(19) United States
(12) Patent Application Publication
(10) Pub. No.: US 2009/0009510 A1
(43) Pub. Date: Jan. 8, 2009

(54) Data line driving circuit, display device and method of driving data line

(75) Inventors: Takayuki Shu, Kanagawa (JP); Yoshiharu Hashimoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/213,774

(22) Filed: Jun. 24, 2008

(30) Foreign Application Priority Data
Jul. 2, 2007 (JP) 2007-174199

(51) Int. Cl. G09G 3/00

(52) U.S. Cl. 345/215

(57) ABSTRACT

A data line driving circuit in a display device has an output terminal and a precharge circuit. The output terminal is connected to a pixel of a display panel through a data line. A gray-scale voltage corresponding to a display data is applied to the data line through the output terminal. The precharge circuit precharges the output terminal to a precharge voltage before the gray-scale voltage is applied to the data line. The precharge voltage depends on the gray-scale voltage.

### INCORPORATION BY REFERENCE

This application is based upon and claims the benefit of priority from Japanese patent application No. 2007-174199, filed on Jul. 2, 2007, the disclosure of which is incorporated herein in its entirely by reference.

### BACKGROUND OF THE INVENTION

1. Field of the Invention

The present invention relates to a technique of driving a data line in a display device. In particular, the present invention relates to a display device, a data line driving circuit in the display device, and a method of driving a data line in the display device.

2. Description of Related Art

A mobile electronic device having a color display device is known. For example, a mobile terminal such as a notebook computer and a PDA (Personal Digital Assistant) or a mobile communication device such as a cell phone and a PHS (Personal Handyphone System) has a color display device (e.g. color liquid crystal display). Such a mobile electronic device enters “stand-by model” if not operated for a certain period of time. During the stand-by mode, a stand-by screen is displayed on a display panel of the color display device of the mobile electronic device. In a case of the cell phone, for example, a battery mark indicating a battery charging condition, an antenna mark indicating incoming signal strength, time information and the like are displayed on the stand-by screen. Such the information on the stand-by screen can be sufficiently expressed by using at most eight colors. Therefore, the color display device of the mobile electronic device is provided with “power-saving mode” for reducing power consumption. In the power-saving mode, the color display device represents each of three colors (R, G, B) of one pixel with a binary signal. In other words, the color display device displays a pixel by using only eight colors during the power-saving mode (also referred to as “eight-color mode” hereinafter).

Japanese Laid-Open Patent Application JP-2002-215115 discloses a color display device that supports the eight-color mode.

FIG. 1 schematically shows an output circuit in a data line driving circuit of the color display device described in the patent document JP-2002-215115. One output circuit 150n connected to one data line is shown in FIG. 1. The output circuit 150n is connected to data electrodes of pixels of an LCD (Liquid Crystal Display) panel through the data line and supplies a gray-scale voltage corresponding to a pixel data (display data) as a data signal Sn to the data line. More specifically, the output circuit 150n has: an output terminal 320n connected to the data line; a gray-scale voltage control switch 330n provided between the output terminal 320n and a gray-scale voltage supply terminal 350n; a gray-scale voltage control switch 340n provided between the output terminal 320n and a gray-scale voltage supply terminal 360n; an output control circuit 310n for ON/OFF controlling the gray-scale voltage control switches 330n and 340n; an operational amplifier 200n; and a mode selector switch 220n provided between the output terminal 320n and an output terminal 210n of the operational amplifier 200n.

FIG. 2 schematically shows a gray-scale voltage generation circuit used in the data line driving circuit. The gray-scale voltage generation circuit generates a plurality of gray-scale voltages V0 to V63. More specifically, the gray-scale voltage generation circuit is provided with dividing resistors R₀ to R₆₄ that are serially connected between a first power source VDD and a second power source GND such that the gray-scale voltages V0 to V63 are generated. Input terminals of operational amplifiers OP₀ to OP₆₃ are respectively connected to connection points of the dividing resistors R₀ to R₆₄. Thus, the operational amplifiers OP₀ to OP₆₃ output the gray-scale voltages V0 to V63, respectively.

The gray-scale voltage generation circuit shown in FIG. 2 outputs the gray-scale voltages V0 to V63 to a gray-scale voltage selection circuit (not shown). The gray-scale voltage selection circuit selects a gray-scale voltage corresponding to the pixel data (display data) from the gray-scale voltages V0 to V63 and outputs the selected gray-scale voltage to the operational amplifier 200n shown in FIG. 1. The operational amplifier 200n outputs the received gray-scale voltage to the output terminal 320n through the mode selector switch 220n.

Referring back to FIG. 1, the gray-scale voltage supply terminals 350n and 360n are provided for supplying a high-level voltage and a low-level voltage to the output terminal 320n, respectively. It should be noted that brightness of the pixel is different between the cases of the high-level voltage and the low-level voltage. For example, the gray-scale voltage V0 (high-level voltage) is supplied through the gray-scale voltage supply terminal 350n, while the gray-scale voltage V63 (low-level voltage) is supplied through the gray-scale voltage supply terminal 360n, as shown in FIG. 1. In this case, the operational amplifiers OP₀ and OP₆₃ of the gray-scale voltage generation circuit shown in FIG. 2 supplies the gray-scale voltages V0 and V63 to the gray-scale voltage supply terminals 350n and 360n, respectively.

The output control circuit 310n controls ON/OFF of the gray-scale voltage control switches 330n and 340n in accordance with a polarity signal POL, a color mode signal CM and the most significant bit MSBn of the display data. More specifically, the output control circuit 310n outputs voltage selection signals SWV0n and SWV63n to the gray-scale voltage control switches 330n and 340n, respectively. The gray-scale voltage control switches 330n and 340n are ON/OFF controlled by the voltage selection signals SWV0n and SWV63n, respectively. Signal levels of the respective voltage selection signals SWV0n and SWV63n are determined depending on the polarity signal POL, the color mode signal CM and the most significant bit MSBn.

The mode selector switch 220n is ON/OFF controlled by a switch control signal SWA output from a controller (not shown). The switch control signal SWA depends on the above-mentioned color mode signal CM. The color mode signal CM specifies an operation mode of the color display device. For example, the color display device operates in a normal mode (full-color mode) if the color mode signal CM is “Low” level, while operates in the eight-color mode if the color mode signal CM is “High” level.

The full-color mode and eight-color mode will be described below in more detail. In the description below, a high-level signal may be expressed as “signal name (Hi)” and a low-level signal may be expressed as “signal name (Low)”.

In the full-color mode (normal mode), the color mode signal CM(Low) and the switch control signal SWA(Hi) are input to the output circuit 150n. In this case, the output control circuit 310n outputs the voltage selection signals SWV0n(Low) and SWV63n(Low) and thus both the gray-scale voltage control switches 330n and 340n are turned OFF. On the other hand, the mode selector switch 220n is turned ON and thus the operational amplifier 200n is electrically connected to the output terminal 320n. The operational amplifier 200n outputs the gray-scale voltage that is selected by the gray-scale voltage selection circuit and corresponds to the display data. Consequently, the gray-scale voltage corresponding to the display data is output as the data signal Sn from the output terminal 320n to the data line.

In the eight-color mode, the color mode signal CM(High) and the switch control signal SWA(Low) are input to the output circuit 150n. In this case, the mode selector switch 220n is turned OFF and thus the operational amplifier 200n is electrically disconnected from the output terminal 320n. Also, supply of a bias current BC to the operational amplifier 200n is cut off. On the other hand, the output control circuit 310n sets one of the voltage selection signals SWV0n and SWV63n to “High” level, depending on the polarity signal POL and the most significant bit MSBn of the display data. Therefore, one of the gray-scale voltage control switches 330n and 340n is turned ON. As a result, the gray-scale voltage V0 or V63 is output as the data signal Sn from the output terminal 320n to the data line.

FIG. 3 is a timing chart showing an operation example of the output circuit 150n during the eight-color mode. A strobe signal STB, the most significant bit MSBn of the display data, the polarity signal POL, a common voltage VCOM, the color mode signal CM, the voltage selection signals SWV0n and SWV63n, the switch control signal SWA and the data signal Sn are shown in FIG. 3. In the initial state of one horizontal period, the gray-scale voltage control switches 330n and 340n are turned OFF.

At time T0, a first horizontal period starts. In the first horizontal period, the polarity signal POL is “High” level and the most significant bit MSBn is “1”. At the time T0, the color mode signal CM changes from “Low” to “Hi” and the output circuit 150n enters the eight-color mode. In response to the color mode signal CM(Hi), the switch control signal SWA(Low) is input and hence the mode selector switch 220n is turned OFF.

At time T1, the output control circuit 310n outputs the voltage selection signals SWV0n(Hi) and SWV63n(Low) in accordance with the polarity signal POL(Hi) and the most significant bit MSBn=1. The gray-scale voltage control switch 330n is turned ON in response to the voltage selection signal SWV0n(Hi), while the gray-scale voltage control switch 340n remains OFF due to the voltage selection signal SWV63n(Low). Consequently, the gray-scale voltage V0 is supplied to the output terminal 320n (i.e. data signal Sn=V0).

At time T2 before the end of the first horizontal period, the voltage selection signal SWV0n is changed from “High” level to “Low” level. After that, a second horizontal period starts. In the second horizontal period, the polarity signal POL is “Low” level and the most significant bit MSBn is “1”. That is, the polarity signal POL is switched from “Hi” to “Low”.

At time T3, the output control circuit 310n outputs the voltage selection signals SWV0n(Low) and SWV63n(Hi) in accordance with the polarity signal POL(Low) and the most significant bit MSBn=1. The gray-scale voltage control switch 340n is turned ON in response to the voltage selection signal SWV63n(Hi), while the gray-scale voltage control switch 330n remains OFF due to the voltage selection signal SWV0n(Low). Consequently, the gray-scale voltage V63 is supplied to the output terminal 320n (i.e. data signal Sn=V63).

At time T4 before the end of the second horizontal period, the voltage selection signal SWV63n is changed from “High” level to “Low” level. After that, the next horizontal period starts.

In this manner, the gray-scale voltage V0 or V63 is supplied to one data line through the output terminal 320n. in other words, each of three colors (R, G, B) of one pixel is represented by a binary signal (V0 or V63). Thus, the “eight-color mode” is achieved. During the eight-color mode, the operational amplifier 200n is not used and the supply of the bias current BC to the operational amplifier 200n is cut off. Therefore, power consumption of the data line driving circuit can be reduced in the eight-color mode.

The inventors of the present application have recognized the following points. The output circuit 150 as shown in FIG. 1 is provided with respect to each of a plurality of data lines of a display panel. For example, when the display panel has n data lines, n output circuits 150 are respectively connected to the n data lines. Here, let us consider a case where the same gray-scale voltage V0 (or V63) is applied to all of the n data lines in the eight-color mode. In this case, the maximum load corresponding to the n data lines is applied to the one operational amplifier OP₀ (or OP₆₃) in the gray-scale voltage generation circuit shown in FIG. 2. The maximum load has been increasing in recent years due to increase in the number of pixels (i.e. data lines) of the color display device. For this reason, it is necessary to enhance capability of the operational amplifiers OP₀ and OP₆₃. However, voltage drop due to the load current cannot be suppressed sufficiently. Therefore, as shown in FIG. 2, capacitors C0 and C63 are connected to output terminals of the operational amplifiers OP₀ and OP₆₃, respectively, in order to suppress the voltage drop. However, this leads to increasing in cost of manufacturing.

### SUMMARY

In an aspect of the present invention, a data line driving circuit in a display device is provided. The data line driving circuit has an output terminal and a precharge circuit. The output terminal is connected to a pixel of a display panel through a data line. A gray-scale voltage corresponding to a display data is applied to the data line through the output terminal. The precharge circuit precharges the output terminal to a precharge voltage before the gray-scale voltage is applied to the data line. The precharge voltage depends on the gray-scale voltage.

In another aspect of the present invention, a display device is provided. The display device has a display panel and a data line driving circuit. The display panel has a pixel connected to a data line. The data line driving circuit is connected to the data line through an output terminal and applies a gray-scale voltage corresponding to a display data to the data line. The data line driving circuit includes a precharge circuit. The precharge circuit precharges the output terminal to a precharge voltage before the gray-scale voltage is applied to the data line. The precharge voltage depends on the gray-scale voltage.

In still another aspect of the present invention, a method of driving a data line is provided. The data line is connected to a pixel of a display panel of a display device. The method includes: (A) precharging the data line to a precharge voltage; and (B) applying a gray-scale voltage corresponding to a display data to the data line after the precharging. The precharge voltage depends on the gray-scale voltage.

As described above, the output terminal of the data line driving circuit is precharged to the precharge voltage before the gray-scale voltage is supplied to the data line. Therefore, the load applied to an operational amplifier that supplies the gray-scale voltage can be reduced. Since the voltage drop can be suppressed sufficiently, it is not necessary to provide a capacitor connected to an output terminal of the operational amplifier. Consequently, the cost of manufacturing can be reduced.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 schematically shows an output circuit in a data line driving circuit according to a related art;

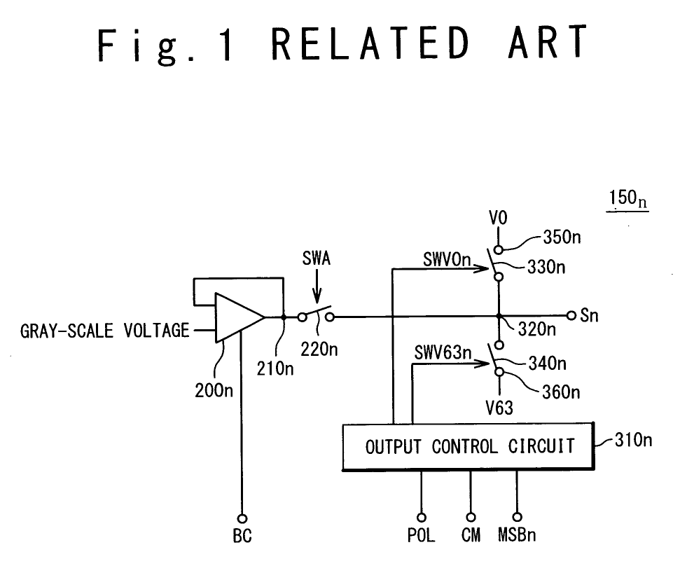

FIG. 2 schematically shows a gray-scale voltage generation circuit used in the data line driving circuit according to the related art;

FIG. 3 is a timing chart showing an operation example of the output circuit shown in FIG. 1 during the eight-color mode;

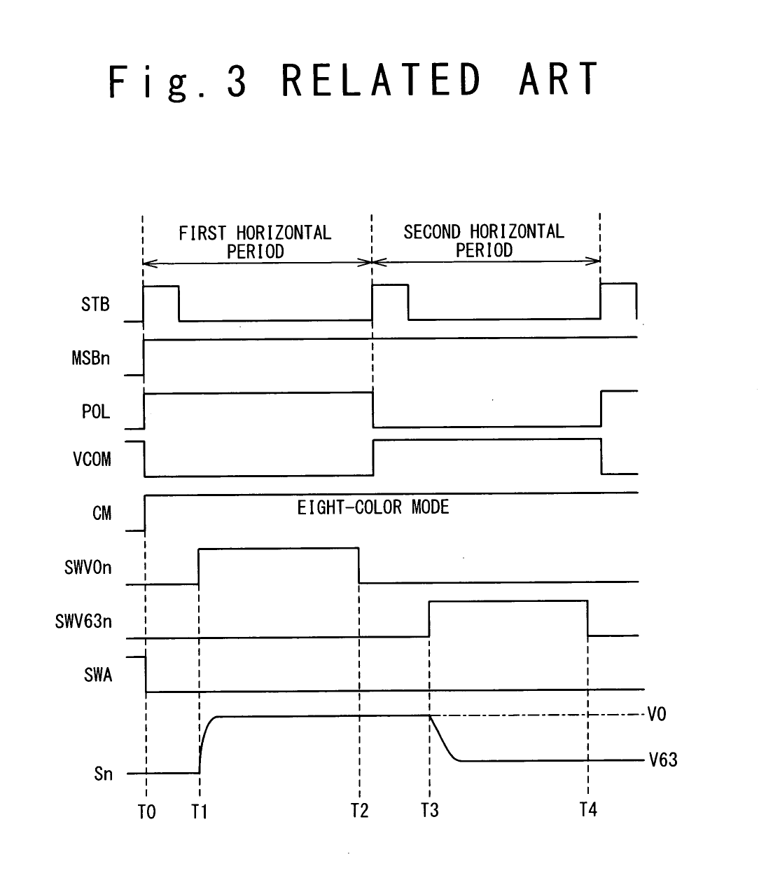

FIG. 4 is a block diagram showing a configuration of a display device according to an embodiment of the present invention;

FIG. 5 is a block diagram showing a configuration of a data driver (data line driving circuit) according to first and second embodiments of the present invention;

FIG. 6 is a circuit diagram showing a gray-scale voltage generation circuit according to an embodiment of the present invention;

FIG. 7 is a block diagram showing a configuration of a gray-scale voltage selection circuit and an output circuit according to the first and second embodiments of the present invention;

FIG. 8 is a circuit diagram showing a configuration of an output unit in the output circuit according to the first embodiment of the present invention;

FIG. 9 is a timing chart showing an operation example of the data driver (data line driving circuit) according to the first embodiment of the present invention;

FIG. 10 is a circuit diagram showing a configuration of an output unit in the output circuit according to the second embodiment of the present invention;

FIG. 11 is a timing chart showing an operation example of the data driver (data line driving circuit) according to the second embodiment of the present invention;

FIG. 12 is a block diagram showing a configuration of a data driver (data line driving circuit) according to third and fourth embodiments of the present invention;

FIG. 13 is a block diagram showing a configuration of a gray-scale voltage selection circuit and an output circuit according to the third and fourth embodiments of the present invention;

FIG. 14 is a circuit diagram showing a configuration of an output unit in the output circuit according to the third embodiment of the present invention;

FIG. 15 is a timing chart showing an operation example of the data driver (data line driving circuit) according to the third embodiment of the present invention;

FIG. 16 is a circuit diagram showing a configuration of an output unit in the output circuit according to the fourth embodiment of the present invention; and

FIG. 17 is a timing chart showing an operation example of the data driver (data line driving circuit) according to the fourth embodiment of the present invention.

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

According to embodiments of the present invention, a display device, a data line driving circuit in the display device, and a method of driving a data line are provided. As an example, an active-matrix type liquid crystal display device 10 will be described in the embodiments. It should be noted that the same reference numerals are given to the same components and an overlapping description may be omitted as appropriate.

### 1. Liquid Crystal Display Device 10

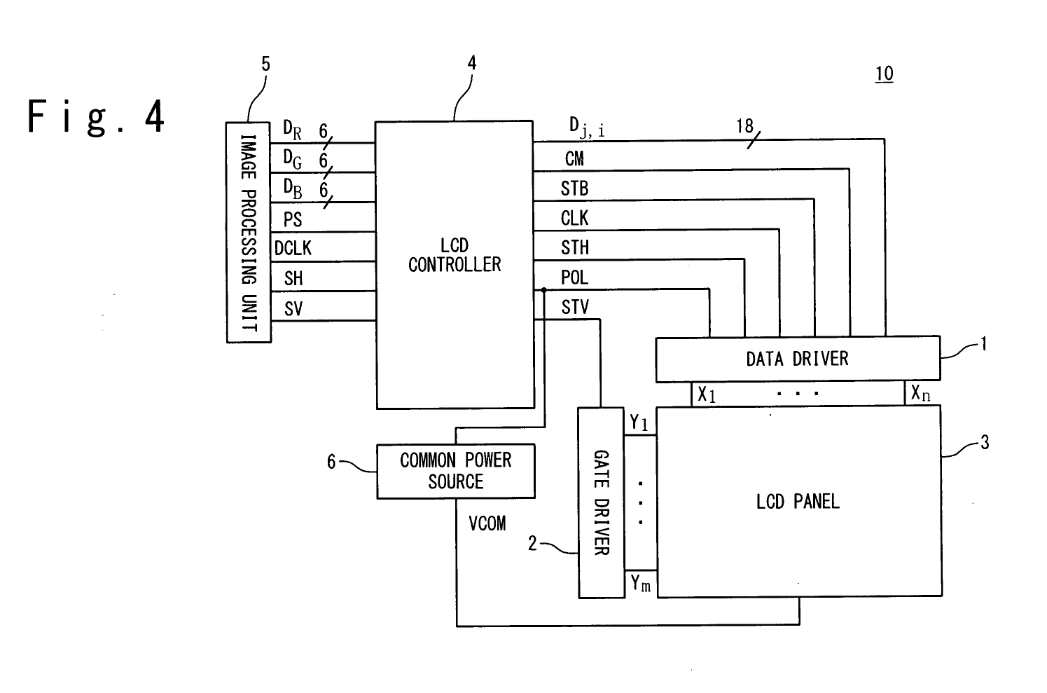

FIG. 4 is a block diagram showing a configuration of the liquid crystal display device 10 according to an embodiment of the present invention. The liquid crystal display device 10 is provided with a data driver (data line driving circuit) 1, a gate driver 2, an LCD panel 3, an LCD controller 4, an image processing unit 5 and a common power source 6. The LCD panel 3 has data lines X1 to Xn arranged in the column direction, scan lines Y1 to Ym arrange in the row direction, and a plurality of pixels. The data lines X1 to Xn and the scan lines Y1 to Ym intersect at a plurality of intersections, and the plurality of pixels (n×m pixels) are provided at the respective intersections. Each of the pixels has a TFT (Thin Film Transistor) and a liquid crystal cell. The liquid crystal cell is a capacitive element having a data electrode and a common electrode. The data electrode is connected to one of the data lines X1 to Xn through the TFT. The common power source 6 applies a common voltage VCOM to the common electrode. A gate electrode of the TFT is connected to one of the scan lines Y1 to Ym, and the TFT is ON/OFF controlled by the gate driver 2. When the TFT of a pixel is turned ON by the gate driver 2 and a data signal (gray-scale voltage) is applied by the data driver 1 to a data line connected to the pixel, the data signal is written to the pixel (liquid crystal cell).

The LCD controller 4 controls the data driver 1 and the gate driver 2 such that a desired image is displayed on the LCD panel 3. More specifically, the LCD controller 4 receives pixel data D_{R}, D_{G} and D_{B} from the image processing unit 5 such as a CPU (Central Processor Unit) and a DSP (Digital Signal Processor). A bit number of each of the pixel data D_{R}, D_{G} and D_{B} depends on the number of colors that the LCD panel 3 is capable of displaying. The LCD controller 4 converts the pixel data D_{R}, D_{G} and D_{B} into display data Dⱼ, ᵢ and transmits the display data Dⱼ, ᵢ to the data driver 1. In a case of the eight-color mode, the image data D_{R}, D_{G} and D_{B} each having 6 bits are input to the LCD controller 4, and the LCD controller 4 transmits the display data Dⱼ, ᵢ with a width of 18 bits to the data driver 1. Here, the display data Dⱼ, ᵢ is a data specifying gray-scale of a pixel connected to the i-th data line Xi and the j-th scan line Yj. Moreover, the LCD controller 4 generates a strobe signal STB, a clock signal CLK, a horizontal start pulse STH, a polarity signal POL and a vertical start pulse STV based on a dot clock signal DCLK, a horizontal synchronization signal SH and a vertical synchronization signal SV which are supplied from the image processing unit 5. The strobe signal STB, clock CLK and horizontal start pulse STH are supplied to the data driver 1, the polarity signal POL is supplied to the data driver 1 and the common power source 6, and the vertical start pulse STV is supplied to the gate driver 2.

The strobe signal STB determines a horizontal period with a cycle depending on the horizontal synchronization signal SH. The horizontal start pulse signal STH is a signal for controlling a timing of the data driver 1 to capture the pixel data Dⱼ, ᵢ, whose cycle depends on the horizontal synchronization signal SH. The vertical start pulse signal STV is a signal for controlling a timing (vertical period) of the gate driver 2 to output scan signals for driving the scan lines Y₁ to Ym, whose cycle depends on the vertical synchronization signal SV. The clock signal CLK is based on the dot clock signal DCLK. The clock signal CLK is used in a shift register 11 described later to generate sampling pulse signals SR1 to SRn for capturing the display data Dⱼ, ᵢ. The polarity signal POL is a signal specifying polarity of the data signal supplied to each data line. In order to AC-drive the LCD panel 3, the polarity signal POL is inverted every horizontal period, i.e. every line (line inversion driving). The polarity signal POL is also inverted every vertical period (frame inversion driving).

The data driver (data line driving circuit) 1 receives the display data Dⱼ, ᵢ from the LCD controller 4 in accordance with the horizontal start pulse signal STH and the clock signal CLK. Then, the data driver 1 selects a gray-scale voltage corresponding to the display data Dⱼ, ᵢ with respect to each of the data lines X1 to Xn. The data driver 1 outputs the selected gray-scale voltages corresponding to the respective display data Dⱼ, ᵢ as data signals S1 to Sn to the respective data lines X1 to Xn. In other words, the data driver 1 connected to each data line drives the each data line (data electrode of each pixel) by applying the gray-scale voltage corresponding to the display data Dⱼ, ᵢ to the each data line. The gate driver 2 drives the scan lines Y₁ to Ym sequentially in accordance with the vertical start pulse STV.

The liquid crystal display device 10 according to the present embodiment can operate in various modes. For example, the first mode is “full-color mode” associated with a normal operation, and the second mode is “eight-color mode” associated with a power saving operation for reducing the power consumption. The full-color mode (normal mode) is for full-color display of an image (still image or moving image) on the LCD panel 3. On the other hand, the eight-color mode (power saving mode) is for reduced-color display on at least a part of the LCD panel 3. In the eight-color mode, each of three colors (R, G, B) of one pixel is represented by a binary signal and the liquid crystal display device 10 displays the pixel by using only eight colors. That is to say, the number of colors displayed on the LCD panel 3 is larger in the full-color mode than in the eight-color mode.

The LCD controller 4 receives a power mode signal PS from the image processing unit 5 and outputs a color mode signal CM depending on the power mode signal PS to the data driver 1. The power mode signal PS specifies whether the liquid crystal display device 10 operates in the normal mode or in the power saving mode. The color mode signal CM specifies whether the liquid crystal display device 10 operates in the full-color mode or in the eight-color mode. If the power mode signal PS indicates the normal mode, the LCD controller 4 outputs the color mode signal CM indicating the full-color mode to the data driver 1 and the liquid crystal display device 10 (data driver 1) operates in the full-color mode. If the power mode signal PS indicates the power saving mode, on the other hand, the LCD controller 4 outputs the color mode signal CM indicating the eight-color mode and the liquid crystal display device 10 (data driver 1) operates in the eight-color mode. For example, the color mode signal CM is set to “Low” level in the case of the full-color mode, while set to “High” level in the case of the eight-color mode. The data driver 1 to which the color mode signal CM(Hi) indicating the eight-color mode is input drives a part of or all of the pixels on the LCD panel 3 by using the binary signal.

Hereinafter, the data driver (data line driving circuit) 1 according to embodiments of the present invention will be described in more detail. As an example, let us consider the data driver 1 that performs 64 gray-scale representation and the line inversion driving.

### 2. First Embodiment

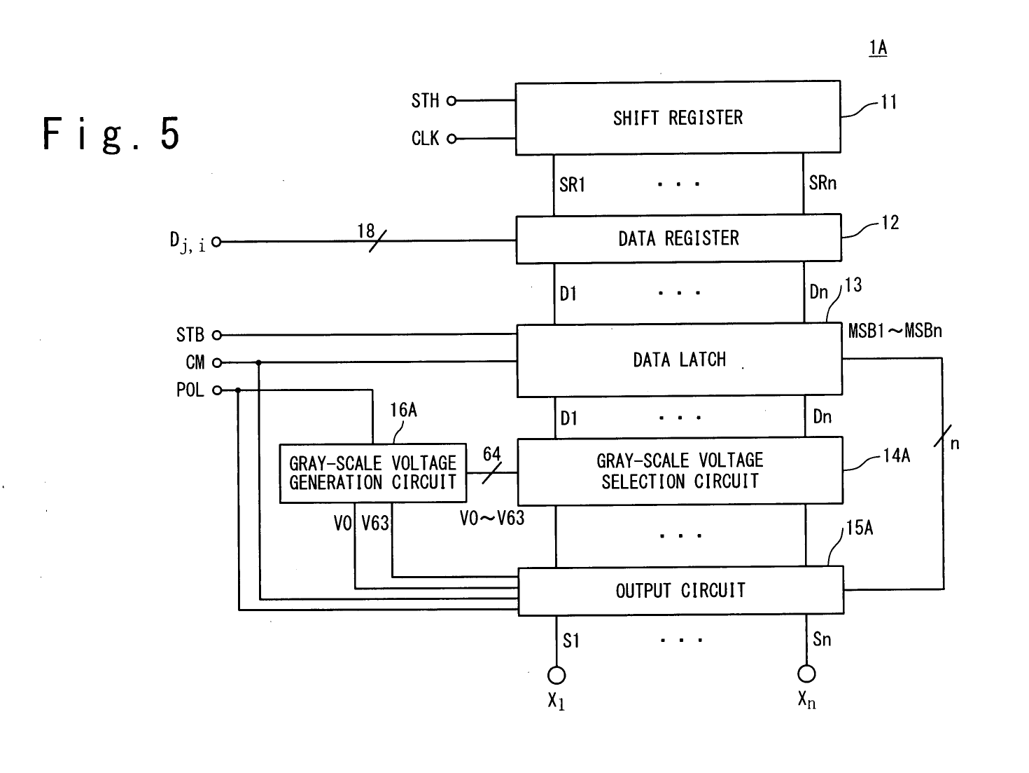

The data driver 1 according to a first embodiment is a data driver 1A shown in FIG. 5. FIG. 5 is a block diagram showing a configuration of the data driver 1A according to the present embodiment. As shown in FIG. 5, the data driver 1A has a shift register 11, a data register 12, a data latch 13, a gray-scale voltage selection circuit 14A, an output circuit 15A and a gray-scale voltage generation circuit 16A.

The shift register 11 generates sampling pulse signals SR1 to SRn based on the horizontal start pulse signal STH and the clock signal CLK, and outputs the sampling pulse signals SR1 to SRn to the data register 12. The shift register 11 activates the sampling pulse signals SR1 to SRn one by one sequentially in each horizontal period. More specifically, the shift register 11 includes n-bit shift registers having parallel outputs, and the horizontal start pulse signal STH and the clock signal CLK are supplied to the n-bit shift registers. When the horizontal start pulse signal STH is activated, a bit “1” is shifted through the n-bit shift registers in synchronization with the clock signal CLK. As a result, the sampling pulse signals SR1 to SRn corresponding to the bit “1” are sequentially activated. Here, the activation order is the normal or reverse order of SR1 to SRn, which can be controlled by a shift direction signal (not shown) issued by the LCD controller 4.

The data register 12 is provided with a plurality of registers whose number is the same as the number (n) of the data lines X1 to Xn. The registers obtain the corresponding display data Dⱼ, ᵢ from the LCD controller 4 in order in response to the above-mentioned sampling pulse signals SR1 to SRn, respectively. In other words, the display data Dⱼ, ᵢ to Dⱼ, ₙ, which are used for driving the pixels on the j-th scan line Yj, are stored in the data register 12 in response to the sampling pulse signals SR1 to SRn, respectively. The stored display data Dⱼ, ₁ to Dⱼ, ₙ are respectively associated with the data lines X1 to Xn and referred to as display data D1 to Dn hereinafter.

The data latch 13 latches the display data D1 to Dn stored in the data register 12 in synchronization with the rising of the strobe signal STB. The data latch 13 holds the latched display data D1 to Dn until the next strobe signal STB is supplied. In other words, the data latch 13 latches and holds the display data D1 to Dn during a horizontal period and latches and holds the next display data D1 to Dn during the next horizontal period. Moreover, the above-mentioned color mode signal CM is input to the data latch 13 according to the present embodiment. In the case of the color mode signal CM(Hi), namely, in the case of the eight-color mode, the data latch 13 outputs the most significant bits MSB1 to MSBn of the respective display data D1 to Dn to the output circuit 15A.

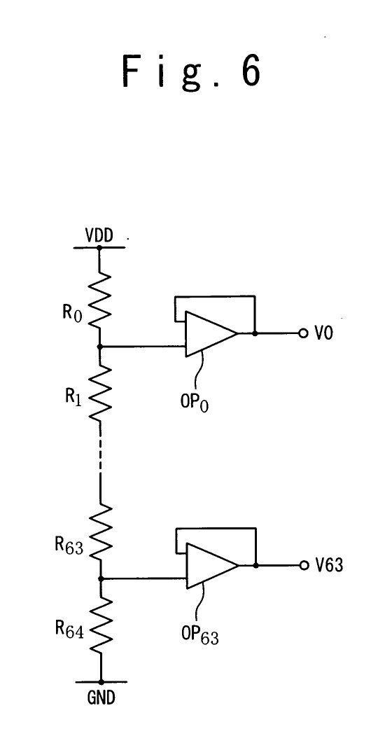

FIG. 6 is a circuit diagram showing the gray-scale voltage generation circuit 16A according to the present embodiment. The gray-scale voltage generation circuit 16A generates a plurality of gray-scale voltages. For example, the gray-scale voltage generation circuit 16A generates 64 gray-scale voltages V0 to V63. As shown in FIG. 6, the gray-scale voltage generation circuit 16A is provided with dividing resistors R₀ to R₆₄ and operational amplifiers OP₀ to OP₆₃. The dividing resistors R₀ to R₆₄ are serially connected between a first power source that supplies a power source voltage VDD (first power source voltage) and a second power source that supplies a ground voltage GND (second power source voltage) lower than the power source voltage VDD. Consequently, the 64 gray-scale voltages V0 to V63 are generated. Input terminals of 64 operational amplifiers OP₀ to OP₆₃ are respectively connected to connection points of the dividing resistors R₀ to R₆₄. Thus, the operational amplifiers OP₀ to OP₆₃ output the gray-scale voltages V0 to V63, respectively.

Referring back to FIG. 5, the gray-scale voltage generation circuit 16A can control the polarity of the gray-scale voltages V0 to V63 in accordance with the polarity signal POL. The gray-scale voltage generation circuit 16A outputs the gray-scale voltages V0 to V63 of the positive polarity or the negative polarity to the gray-scale voltage selection circuit 14A.

The gray-scale voltage selection circuit 14A receives the gray-scale voltages V0 to V63 from the gray-scale voltage generation circuit 16A and the display data D1 to Dn from the data latch 13. Based on the display data D1 to Dn, the gray-scale voltage selection circuit 14A selects gray-scale voltages to be respectively applied to the data lines X1 to Xn from the gray-scale voltages V0 to V63. With regard to a certain data line Xi, the gray-scale voltage selection circuit 14A selects a gray-scale voltage corresponding to the display data Di from the gray-scale voltages V0 to V63. The gray-scale voltage selection circuit 14A outputs the selected gray-scale voltages to the output circuit 15A.

The output circuit 15A is connected to the data lines X1 to Xn and applies gray-scale voltages as data signals S1 to Sn to the data lines X1 to Xn, respectively. The operation of the output circuit 15A depends on the operation mode of the liquid crystal display device 10 and is different between the full-color mode and the eight-color mode. Therefore, the above-mentioned color mode signal CM is input to the output circuit 15A.

In the case of the full-color mode where the color mode signal CM(Low) is input, the output circuit 15A outputs the gray-scale voltages selected by the gray-scale voltage selection circuit 14A as the data signals S1 to Sn to the data lines X1 to Xn, respectively. Therefore, the plurality of gray-scale voltages V0 to V63 generated by the gray-scale voltage generation circuit 16A can be used for driving the LCD panel 3 (data lines X1 to Xn) in the full-color mode.

On the other hand, in the case of the eight-color mode where the color mode signal CM(Hi) is input to the output circuit 15A, predetermined gray-scale voltages whose number is less than in the case of the full-color mode are used for driving the LCD panel 3 (data lines X1 to Xn). More specifically, the output circuit 15A selects either one of two predetermined gray-scale voltages depending on the most significant bit MSBi (from MSB1 to MSBn) of the corresponding display data Di (from D1 to Dn) and the polarity signal POL. In other words, the output circuit 15A selects either one of the two predetermined gray-scale voltages with respect to each of the data lines X1 to Xn, based on the most significant bits MSB1 to MSBn of the display data D1 to Dn and the polarity signal POL. The output circuit 15A outputs the selected gray-scale voltages as the data signals S1 to Sn to the data lines X1 to Xn, respectively. The two predetermined gray-scale voltages include a first gray-scale voltage and a second gray-scale voltage, which are supplied from the gray-scale voltage generation circuit 16A. The first and second gray-scale voltages are different from each other such that brightness of the pixel is different between the cases of the first and second gray-scale voltages. That is to say, the first gray-scale voltage is the higher-level voltage, while the second gray-scale voltage is the lower-level voltage. For example, the first gray-scale voltage is the gray-scale voltage V0 that is the maximum one of the plurality of gray-scale voltages V0 to V63 used in the full-color mode, while the second gray-scale voltage is the gray-scale voltage V63 that is the minimum one of the plurality of gray-scale voltages V0 to V63. In this case, the two predetermined gray-scale voltages V0 and V63 are supplied from the gray-scale voltage generation circuit 16A to the output circuit 15A, as shown in FIG. 5. More specifically, the operational amplifiers OP₀ and OP₆₃ of the gray-scale voltage generation circuit 16A shown in FIG. 6 outputs the gray-scale voltages V0 and V63 to the output circuit 15A.

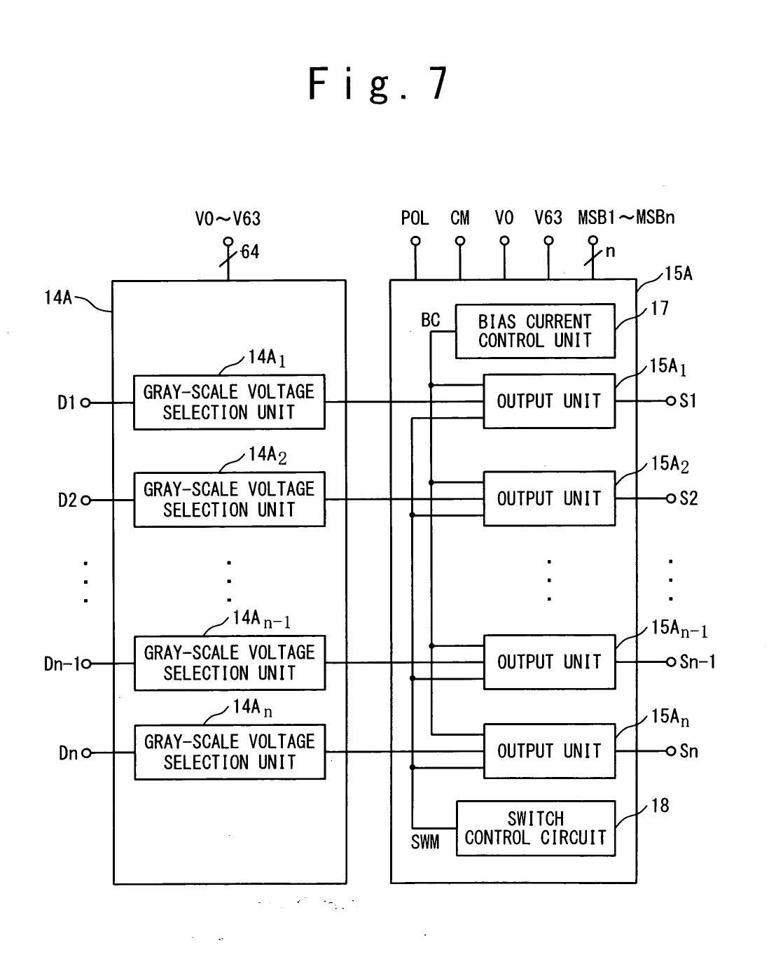

FIG. 7 is a block diagram showing a configuration of the gray-scale voltage selection circuit 14A and the output circuit 15A according to the present embodiment. The gray-scale voltage selection circuit 14A is provided with gray-scale voltage selection units 14A₁ to 14Aₙ associated with the data lines X1 to Xn, respectively. The output circuit 15A is provided with output units 15A₁ to 15Aₙ associated with the data lines X₁ to Xn, respectively. The gray-scale voltages V0 to V63 are input to each of the gray-scale voltage selection units 14A₁ to 14Aₙ. Moreover, the display data D1 to Dn are input to the gray-scale voltage selection units 14A₁ to 14Aₙ, respectively. Each of the gray-scale voltage selection units 14A₁ to 14An selects one gray-scale voltage from the gray-scale voltages V0 to V63 based on the corresponding one of the display data D1 to Dn. Then, the gray-scale voltage selection units 14A₁ to 14An output the selected gray-scale voltages to the output units 15A₁ to 15Aₙ, respectively.

The polarity signal POL, the color mode signal CM and the predetermined two gray-scale voltages V0 and V63 are input to each of the output units 15A₁ to 15Aₙ. The most significant bits MSB1 to MSBn are input to the output units 15A₁ to 15Aₙ, respectively. Moreover, the output circuit 15A is further provided with a bias current control unit 17 and a switch control circuit 18, as shown in FIG. 7. The bias current control unit 17 controls supply of a bias current BC to the output units 15A₁ to 15Aₙ in accordance with the color mode signal CM. As described later, each of the output units 15A₁ to 15Aₙ includes an operational amplifier. In the case of the color mode signal CM(Low), namely the full-color mode, the bias current control unit 17 supplies the bias current BC to the operational amplifier in each output unit 15A. In the case of the color mode signal CM(Hi), namely the eight-color mode, the bias current control unit 17 stop supplying of the bias current BC. The switch control circuit 18 generates a switch control signal SWM in accordance with the color mode signal CM. In the case of the color mode signal CM(Low), namely the full-color mode, the switch control circuit 18 outputs the switch control signal SWM(Hi) to the output units 15A₁ to 15Aₙ. In the case of the color mode signal CM(Hi), namely the eight-color mode, the switch control circuit 18 outputs the switch control signal SWM(Low) to the output units 15A₁ to 15Aₙ.

Next, the details of the output units 15A₁ to 15Aₙ in the output circuit 15A of the data driver 1A will be described. Since the respective output units 15A₁ to 15Aₙ have the same configuration, the output unit 15Aₙ provided between the gray-scale voltage selection unit 14An and the data line Xn will be explained as a representative.

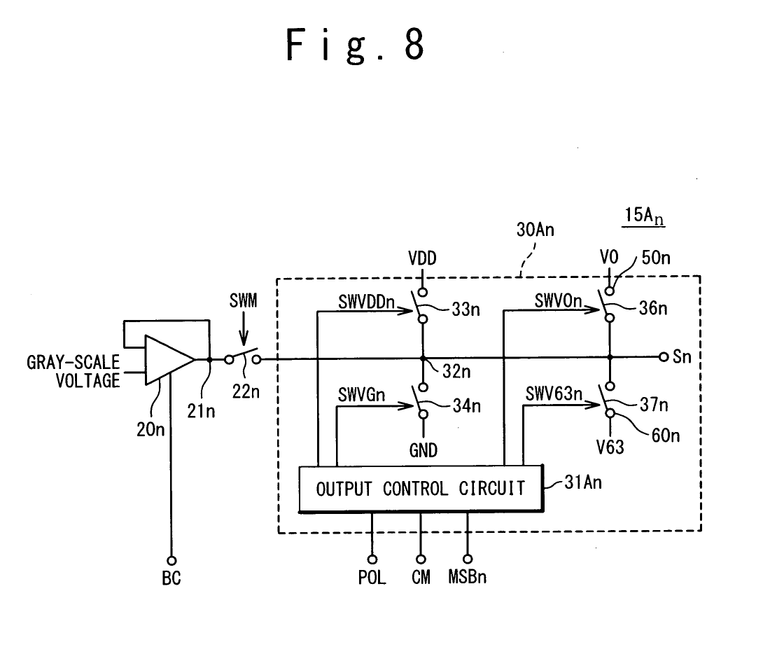

FIG. 8 is a circuit diagram showing a configuration of the output unit 15Aₙ according to the present embodiment. The output unit 15Aₙ is connected to the data line Xn through an output terminal 32n, and outputs a gray-scale voltage corresponding to the display data Dn as the data signal Sn to the data line Xn. As shown in FIG. 8, the output unit 15An includes the output terminal 32n connected to the data line Xn, an operational amplifier 20n, a precharge circuit 30An and a mode selector switch 22n. The mode selector switch 22n is provided between an output terminal 21n of the operational amplifier 20n and the output terminal 32n of the output unit 15Aₙ so as to control an electrical connection between the operational amplifier 20n and the output terminal 32n. The precharge circuit 30An includes precharge voltage selection switches 33n and 34n, gray-scale voltage control switches 36n and 37n, and an output control circuit 31An. Moreover, the precharge circuit 30An includes a gray-scale voltage supply terminal 50n (first gray-scale voltage supply terminal) and a gray-scale voltage supply terminal 60n (second gray-scale voltage supply terminal). The above-mentioned first gray-scale voltage (gray-scale voltage V0) is supplied from the operational amplifiers OP₀ of the gray-scale voltage generation circuit 16A to the gray-scale voltage supply terminal 50n. On the other hand, the above-mentioned second gray-scale voltage (gray-scale voltage V63) is supplied from the operational amplifiers OP₆₃ of the gray-scale voltage generation circuit 16A to the gray-scale voltage supply terminal 60n.

The gray-scale voltage control switch 36n is provided between the output terminal 32n and the gray-scale voltage supply terminal 50n so as to control an electrical connection between the output terminal 32n and the gray-scale voltage supply terminal 50n. The gray-scale voltage control switch 37n is provided between the output terminal 32n and the gray-scale voltage supply terminal 60n so as to control an electrical connection between the output terminal 32n and the gray-scale voltage supply terminal 60n. The precharge voltage selection switch 33n (first precharge voltage selection switch) is provided between the output terminal 32n and the first power source which supplies the power source voltage VDD (first power source voltage) so as to control an electrical connection between the output terminal 32n and the first power source. The precharge voltage selection switch 34n (second precharge voltage selection switch) is provided between the output terminal 32n and the second power source which supplies the ground voltage GND (second power source voltage) so as to control an electrical connection between the output terminal 32n and the second power source. The mode selector switch 22n is ON/OFF controlled by the switch control signal SWM and controls an electrical connection between the output terminal 21n of the operational amplifier 20n and the output terminal 32n. The output control circuit 31An controls the precharge voltage selection switches 33n and 34n and the gray-scale voltage control switches 36n and 37n based on the polarity signal POL, the color mode signal CM and the most significant bit MSBn of the display data Dn. More specifically, the output control circuit 31An generates voltage selection signals SWVDDn, SWVGn, SWV0n and SWV63n based on the polarity signal POL, the color mode signal CM and the most significant bit MSBn of the display data Dn, and outputs the voltage selection signals SWVDDn, SWVGn, SWV0n and SWV63n to control the precharge voltage selection switches 33n and 34n and the gray-scale voltage control switches 36n and 37n, respectively.

In the case of the full-color mode (normal mode) where the color mode signal CM(Low) is input to the output control circuit 31An, the output control circuit 31An outputs the voltage selection signals SWVDDn(Low), SWVGn(Low), SWV0n(Low) and SWV63n(Low) to the precharge voltage selection switches 33n and 34n and the gray-scale voltage control switches 36n and 37n, respectively. Thus, all the precharge voltage selection switches 33n and 34n and the gray-scale voltage control switches 36n and 37n are turned OFF, and the precharge circuit 30An is deactivated. On the other hand, the switch control signal SWM(Hi) is input to the output unit 15Aₙ, and thus the mode selector switch 22n is turned ON. Moreover, the bias current control unit 17 (see FIG. 7) supplies the bias current BC to the operational amplifier 20n. In this case, a gray-scale voltage which is selected by the gray-scale voltage selection unit 14Aₙ (see FIG. 7) and corresponds to the display data Dn is output as the data signal Sn from the operational amplifier 20n to the data line Xn through the output terminal 32n.

In the case of the eight-color mode where the color mode signal CM(Hi) is input to the output control circuit 31An, on the other hand, the switch control signal SWM(Low) is input to the output unit 15Aₙ. Therefore, the mode selector switch 22n is turned OFF and the electrical connection between the operational amplifier 20n and the output terminal 32n is cut off. Moreover, the bias current control unit 17 (see FIG. 7) stops supplying of the bias current BC to the operational amplifier 20n. Instead, the precharge circuit 30An is activated and operates as follows during the eight-color mode. That is, the precharge circuit 30An precharges the output terminal 32n to a “precharge voltage” before a gray-scale voltage is applied to the data line Xn. More specifically, the precharge circuit 30An selects one of the first power source (power source voltage VDD) and the second power source (ground voltage GND) depending on the polarity signal POL and the most significant bit MSBn of the display data Dn, and connects the output terminal 32n with the selected one power source when precharging the output terminal 32n. In other words, the precharge circuit 30An turns ON one of the precharge voltage selection switches 33n and 34n depending on the polarity signal POL and the most significant bit MSBn of the display data Dn. As a result, the selected one of the power source voltage VDD and the ground voltage GND is applied as the precharge voltage to the data line Xn. After the precharging, a gray-scale voltage corresponding to the display data Dn is applied to the data line Xn through the output terminal 32n. Here, the applied gray-scale voltage also depends on the most significant bit MSBn of the display data Dn and the polarity signal POL. That is to say, both of the precharge voltage and the gray-scale voltage applied to the output terminal 32n during the eight-color mode depend on the most significant bit MSBn of the display data Dn and the polarity signal POL. The precharge voltage and the gray-scale voltage are related to each other, and the precharge voltage depends on the gray-scale voltage. For example, in the case when the output control circuit 31An outputs the voltage selection signal SWVDDn(Hi) to turn ON the precharge voltage selection switch 33n and the voltage selection signal SWVGn(Low) to turn OFF the precharge voltage selection switch 34n during the precharging, the output control circuit 31An outputs the voltage selection signal SWV0n(Hi) to turn ON the gray-scale voltage control switch 36n and the voltage selection signal SWV63n(Low) to turn OFF the gray-scale voltage control switch 37n after the precharging. In this case, the precharge voltage is the power source voltage VDD (first power source voltage) and the gray-scale voltage is the gray-scale voltage V0 (first gray-scale voltage). On the other hand, in the case when the output control circuit 31An outputs the voltage selection signal SWVDDn(Low) to turn OFF the precharge voltage selection switch 33n and the voltage selection signal SWVGn(Hi) to turn ON the precharge voltage selection switch 34n during the precharging, the output control circuit 31An outputs the voltage selection signal SWV0n(Low) to turn OFF the gray-scale voltage control switch 36n and the voltage selection signal SWV63n(Hi) to turn ON the gray-scale voltage control switch 37n after the precharging. In this case, the precharge voltage is the ground voltage GND (second power source voltage) and the gray-scale voltage is the gray-scale voltage V63 (second gray-scale voltage). In this manner, either one of the two predetermined gray-scale voltages V0 and V63 is selected and applied to the data line Xn after the corresponding precharge voltage is applied to the data line Xn.

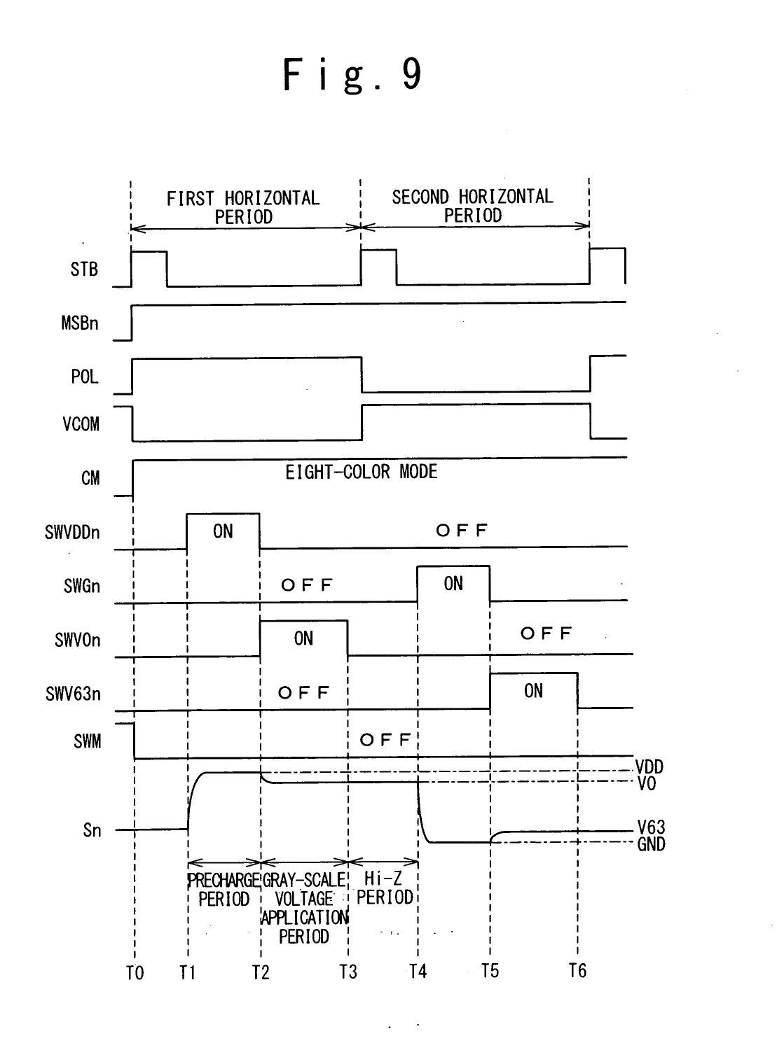

FIG. 9 is a timing chart showing an operation example of the output unit 15Aₙ during the eight-color mode according to the present embodiment. The strobe signal STB, the most significant bit MSBn of the display data Dn, the polarity signal POL, the common voltage VCOM, the color mode signal CM, the voltage selection signals SWVDDn, SWGn, SWV0n and SWV63n, the switch control signal SWM and the data signal Sn are shown in FIG. 9. In the initial state of one horizontal period, the precharge voltage selection switches 33n and 34n and the gray-scale voltage control switches 36n and 37n are turned OFF.

At time T0, a first horizontal period starts. In the first horizontal period, the polarity signal POL is “High” level and the most significant bit MSBn input to the output unit 15Aₙ is “1”. At the time T0, the color mode signal CM changes from “Low” to “Hi” and the output unit 15Aₙ enters the eight-color mode. In response to the color mode signal CM(Hi), the switch control signal SWM(Low) is input from the switch control circuit 18 and hence the mode selector switch 22n is turned OFF.

At time T1, the output control circuit 31An outputs the voltage selection signals SWVDDn(Hi), SWVGn(Low), SWV0n(Low) and SWV63n(Low) in accordance with the polarity signal POL(Hi) and the most significant bit MSBn=1. In response to these voltage selection signals, only the precharge voltage selection switch 33n is turned ON and thus the output terminal 32n is precharged to the power source voltage VDD (precharge voltage).

At time T2 after the precharge period, the output control circuit 31An changes the voltage selection signal SWVDDn to “Low” and the voltage selection signal SWV0n to “Hi”. Thus, the precharge voltage selection switch 33n is turned OFF, while the gray-scale voltage control switch 36n is turned ON. Consequently, the gray-scale voltage V0 (first gray-scale voltage) is supplied to the output terminal 32n from the gray-scale voltage generation circuit 16A through the gray-scale voltage control switch 36n.

From the time T2 to T3 (gray-scale voltage application period), the gate driver 2 drives one of the scan lines Y1 to Ym, and the gray-scale voltage V0 is applied as the data signal Sn to a pixel through the data line Xn. At the time T3 after the gray-scale voltage application period, the output control circuit 31An changes the voltage selection signal SWV0n to “Low” and turns OFF the gray-scale voltage control switch 36n.

From the time T3 to T4 (Hi-Z period), the output terminal 32n is set to the high-impedance state. During this Hi-Z period, the first horizontal period is ended and the next horizontal period (second horizontal period) is started. In the second horizontal period, the polarity signal POL is “Low” level and the most significant bit MSBn is “1”. That is, the polarity signal POL is switched from “Hi” to “Low”, and the polarity of the common voltage VCOM is inverted.

At time T4, the output control circuit 31An outputs the voltage selection signals SWVDDn(Low), SWVGn(Hi), SWV0n(Low) and SWV63n(Low) in accordance with the polarity signal POL(Low) and the most significant bit MSBn=1. In response to these voltage selection signals, only the precharge voltage selection switch 34n is turned ON and thus the output terminal 32n is precharged to the ground voltage GND (precharge voltage).

At time T5 after the precharge period, the output control circuit 31An changes the voltage selection signal SWVGn to “Low” and the voltage selection signal SWV63n to “Hi”. Thus, the precharge voltage selection switch 34n is turned OFF, while the gray-scale voltage control switch 37n is turned ON. Consequently, the gray-scale voltage V63 (second gray-scale voltage) is supplied to the output terminal 32n from the gray-scale voltage generation circuit 16A through the gray-scale voltage control switch 37n.

From the time T5 to T6 (gray-scale voltage application period), the gate driver 2 drives one of the scan lines Y1 to Ym, and the gray-scale voltage V63 is applied as the data signal Sn to a pixel through the data line Xn. At the time T6 after the gray-scale voltage application period, the output control circuit 31An changes the voltage selection signal SWV63n to “Low” and turns OFF the gray-scale voltage control switch 37n.

As described above, the data driver 1A according to the present embodiment can be switched from the normal mode (full-color mode) to the eight-color mode. In the eight-color mode, the data driver 1A outputs the two predetermined gray-scale voltages (V0, V63) as the data signals S1 to Sn to the respective data lines X1 to Xn for driving each pixel on the LCD panel 3. During the eight-color mode, the operational amplifier 20n is not used and the supply of the bias current BC to the operational amplifier 20n is cut off. Therefore, the power consumption of the data driver 1A can be reduced in the eight-color mode.

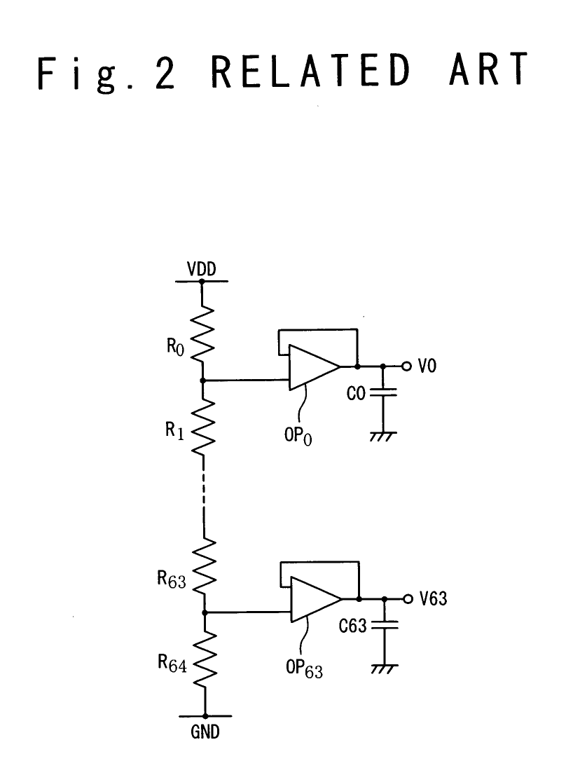

Moreover, the data driver 1A according to the present embodiment precharges the data lines X1 to Xn before the data signals S1 to Sn are applied to the respective data lines X1 to Xn. For example, the data line Xn is precharged to the power source voltage VDD or the ground voltage GND depending on the display data Dn. In other words, the data line Xn is precharged to the precharge voltage (VDD or GND) which is near the gray-scale voltage (V0 or V63) during the precharge period. Therefore, when the data signal Sn is applied to a pixel, the load for outputting the data signal Sn can be reduced. That is to say, the load applied to the operational amplifier OP₀ or OP₆₃ in the gray-scale voltage generation circuit 16A can be reduced when the gray-scale voltage (V0 or V63) is supplied to the data lines X1 to Xn during the eight-color mode. Since the voltage drop can be suppressed sufficiently, it is not necessary to provide a capacitor connected to an output terminal of the operational amplifier OP₀ or OP₆₃ in the gray-scale voltage generation circuit 16A. It should be noted that such a capacitor is provided in the case of FIG. 2, while not provided according to the present embodiment as shown in FIG. 6. Consequently, the cost of manufacturing can be reduced.

### 3. Second Embodiment

In a second embodiment of the present invention, the data driver 1 is provided with output units 15B₁ to 15Bₙ instead of the output units 15A₁ to 15Aₙ described in the first embodiment. The data driver 1 according to the second embodiment has the same configuration as in the first embodiment except for the output unit 15B₁ to 15Bₙ. In the second embodiment, the same reference numerals are given to the same components as those described in the first embodiment, and an overlapping description will be omitted as appropriate. Since the respective output units 15B₁ to 15Bₙ have the same configuration, the output unit 15Bₙ provided between the gray-scale voltage selection unit 14An and the data line Xn will be explained as a representative.

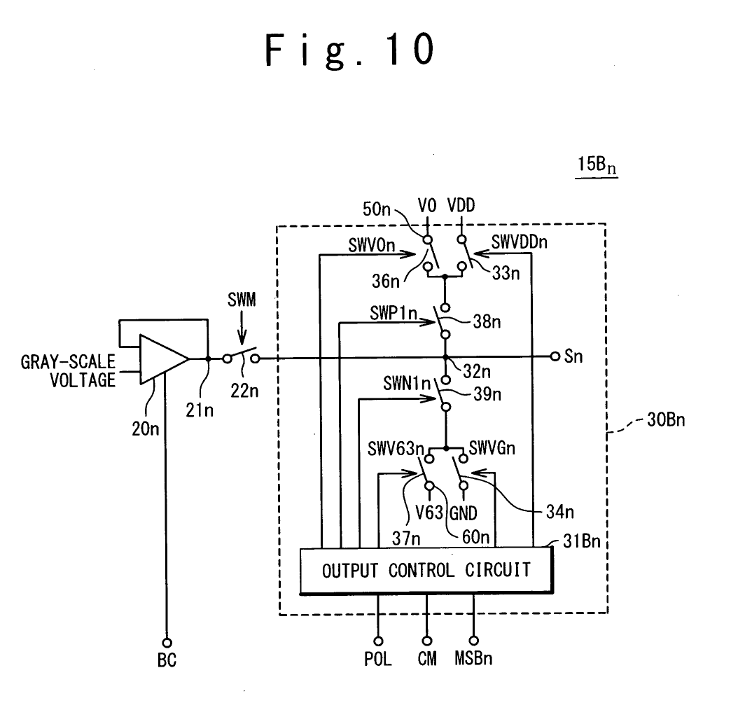

FIG. 10 is a circuit diagram showing a configuration of the output unit 15Bₙ according to the present embodiment. The output unit 15Bₙ is connected to the data line Xn through the output terminal 32n, and outputs a gray-scale voltage corresponding to the display data Dn as the data signal Sn to the data line Xn. As shown in FIG. 10, the output unit 15Bn includes the output terminal 32n, the operational amplifier 20n, a precharge circuit 30Bn and the mode selector switch 22n. The mode selector switch 22n is ON/OFF controlled by the switch control signal SWM. The precharge circuit 30Bn includes voltage selector switches 38n and 39n in addition to the precharge circuit 30An described in the first embodiment. Moreover, the precharge circuit 30Bn includes an output control circuit 31Bn instead of the output control circuit 31An described in the first embodiment. The voltage selector switch 38n is used for controlling electrical connection between the output terminal 32n and the higher-voltage side (the gray-scale voltage supply terminal 50n for supplying the gray-scale voltage V0 and the first power source for supplying the power source voltage VDD). The voltage selector switch 39n is used for controlling electrical connection between the output terminal 32n and the lower-voltage side (the gray-scale voltage supply terminal 60n for supplying the gray-scale voltage V63 and the second power source for supplying the ground voltage GND).

In the second embodiment, one end of the gray-scale voltage control switch 36n is connected to the gray-scale voltage supply terminal 50n, and the other end thereof is connected to the output terminal 32n through the voltage selector switch 38n. One end of the precharge voltage selection switch 33n is connected to the first power source (power source voltage VDD), and the other end thereof is connected to the output terminal 32n through the voltage selector switch 38n. One end of the gray-scale voltage control switch 37n is connected to the gray-scale voltage supply terminal 60n, and the other end thereof is connected to the output terminal 32n through the voltage selector switch 39n. One end of the precharge voltage selection switch 34n is connected to the second power source (ground voltage GND), and the other end thereof is connected to the output terminal 32n through the voltage selector switch 39n. The output control circuit 31Bn controls the voltage selector switches 38n and 39n in addition to the precharge voltage selection switches 33n and 34n and the gray-scale voltage control switches 36n and 37n, based on the polarity signal POL, the color mode signal CM and the most significant bit MSBn of the display data Dn. More specifically, the output control circuit 31Bn generates voltage switch signals SWP1n and SWN1n based on the polarity signal POL, the color mode signal CM and the most significant bit MSBn of the display data Dn, and outputs the voltage switch signals SWP1n and SWN1n to control the voltage selector switches 38n and 39n, respectively.

In the case of the full-color mode (normal mode) where the color mode signal CM(Low) is input to the output control circuit 31Bn, the output control circuit 31Bn outputs the voltage switch signals SWP1n(Low) and SWN1n(Low). As a result, the voltage selector switches 38n and 39n are turned OFF, and the precharge circuit 30Bn is deactivated. On the other hand, the switch control signal SWM(Hi) is input to the output unit 15Bₙ, and thus the mode selector switch 22n is turned ON. Thus, a gray-scale voltage which is selected by the gray-scale voltage selection unit 14Aₙ (see FIG. 7) and corresponds to the display data Dn is output as the data signal Sn from the operational amplifier 20n to the data line Xn.

In the case of the eight-color mode where the color mode signal CM(Hi) is input to the output control circuit 31Bn, on the other hand, the switch control signal SWM(Low) is input to the output unit 15Bₙ and the mode selector switch 22n is turned OFF. Moreover, the bias current control unit 17 (see FIG. 7) stops supplying of the bias current BC to the operational amplifier 20n. Instead, the precharge circuit 30Bn is activated and precharges the output terminal 32n to the precharge voltage (VDD or GND) before the gray-scale voltage (V0 or V63) is applied to the data line Xn as in the first embodiment.

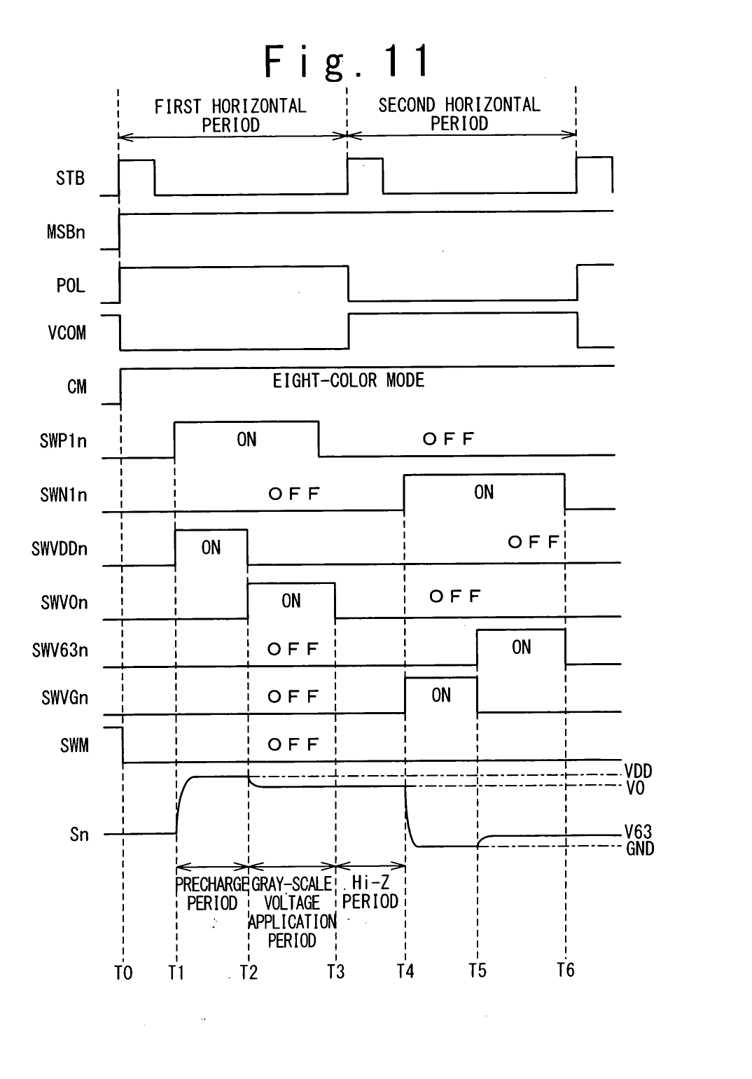

FIG. 11 is a timing chart showing an operation example of the output unit 15Bₙ during the eight-color mode according to the present embodiment. In the initial state of one horizontal period, the precharge voltage selection switches 33n and 34n, the gray-scale voltage control switches 36n and 37n and the voltage selector switches 38n and 39n are turned OFF.

At time T0, a first horizontal period starts. In the first horizontal period, the polarity signal POL is “High” level and the most significant bit MSBn input to the output unit 15Bₙ is “1”. At the time T0, the color mode signal CM changes from “Low” to “Hi” and the output unit 15Bₙ enters the eight-color mode. In response to the color mode signal CM(Hi), the switch control signal SWM(Low) is input from the switch control circuit 18 and hence the mode selector switch 22n is turned OFF.

At time T1, the output control circuit 31Bn outputs the voltage switch signals SWP1n(Hi) and SWN1n(Low), the voltage selection signals SWVDDn(Hi), SWVGn(Low), SWV0n(Low) and SWV63n(Low) in accordance with the polarity signal POL(Hi) and the most significant bit MSBn=1. In response to these voltage selection signals, the voltage selector switch 38n and the precharge voltage selection switch 33n are turned ON and thus the output terminal 32n is precharged to the power source voltage VDD (precharge voltage).

At time T2 after the precharge period, the output control circuit 31Bn changes the voltage selection signal SWVDDn to “Low” and the voltage selection signal SWV0n to “Hi”. Thus, the precharge voltage selection switch 33n is turned OFF, while the gray-scale voltage control switch 36n is turned ON. Consequently, the gray-scale voltage V0 (first gray-scale voltage) is supplied to the output terminal 32n from the gray-scale voltage generation circuit 16A through the gray-scale voltage control switch 36n.

From the time T2 to T3 (gray-scale voltage application period), the gate driver 2 drives one of the scan lines Y1 to Ym, and the gray-scale voltage V0 is applied as the data signal Sn to a pixel through the data line Xn. At the time T3 after the gray-scale voltage application period, the output control circuit 31Bn changes the voltage switch signal SWP1n and the voltage selection signal SWV0n to “Low” so as to turn OFF the voltage selector switch 38n and the gray-scale voltage control switch 36n.

From the time T3 to T4 (Hi-Z period), the output terminal 32n is set to the high-impedance state. During this Hi-Z period, the first horizontal period is ended and the next horizontal period (second horizontal period) is started. In the second horizontal period, the polarity signal POL is “Low” level and the most significant bit MSBn is “1”. That is, the polarity signal POL is switched from “Hi” to “Low”, and the polarity of the common voltage VCOM is inverted.

At time T4, the output control circuit 31Bn outputs the voltage switch signals SWP1n(Low) and SWN1n(Hi), the voltage selection signals SWVDDn(Low), SWVGn(Hi), SWV0n(Low) and SWV63n(Low) in accordance with the polarity signal POL(Low) and the most significant bit MSBn=1. In response to these voltage selection signals, the voltage selector switch 39n and the precharge voltage selection switch 34n are turned ON and thus the output terminal 32n is precharged to the ground voltage GND (precharge voltage) At time T5 after the precharge period, the output control circuit 31Bn changes the voltage selection signal SWVGn to “Low” and the voltage selection signal SWV63n to “Hi”. Thus, the precharge voltage selection switch 34n is turned OFF, while the gray-scale voltage control switch 37n is turned ON. Consequently, the gray-scale voltage V63 (second gray-scale voltage) is supplied to the output terminal 32n from the gray-scale voltage generation circuit 16A through the gray-scale voltage control switch 37n.

From the time T5 to T6 (gray-scale voltage application period), the gate driver 2 drives one of the scan lines Y1 to Ym, and the gray-scale voltage V63 is applied as the data signal Sn to a pixel through the data line Xn. At the time T6 after the gray-scale voltage application period, the output control circuit 31Bn changes the voltage switch signal SWN1n and the voltage selection signal SWV63n to “Low” so as to turn OFF the voltage selector switch 39n and the gray-scale voltage control switch 37n.

As described above, the data driver 1 according to the present embodiment precharges the data lines X1 to Xn before the data signals S1 to Sn are applied to the respective data lines X1 to Xn. For example, the data line Xn is precharged to the power source voltage VDD or the ground voltage GND depending on the display data Dn. In other words, the data line Xn is precharged to the precharge voltage (VDD or GND) which is near the gray-scale voltage (V0 or V63) during the precharge period. Therefore, when the data signal Sn is applied to a pixel, the load for outputting the data signal Sn can be reduced. That is to say, the load applied to the operational amplifier OP₀ or OP₆₃ in the gray-scale voltage generation circuit 16A can be reduced when the gray-scale voltage (V0 or V63) is supplied to the data lines X1 to Xn during the eight-color mode. Since the voltage drop can be suppressed sufficiently, it is not necessary to provide a capacitor connected to an output terminal of the operational amplifier OP₀ or OP₆₃ in the gray-scale voltage generation circuit 16A. Consequently, the cost of manufacturing can be reduced.

### 4. Third Embodiment

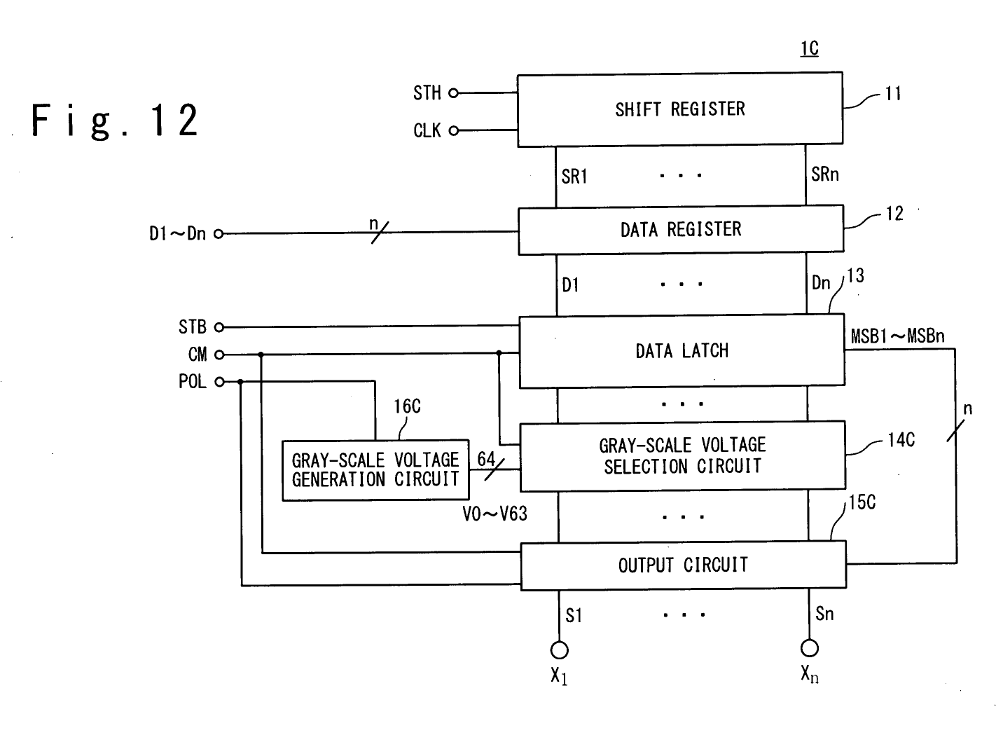

The data driver 1 according to a third embodiment of the present invention is a data driver 1C shown in FIG. 12. FIG. 12 is a block diagram showing a configuration of the data driver 1C according to the third embodiment. In the third embodiment, the same reference numerals are given to the same components as those described in the first embodiment, and an overlapping description will be omitted as appropriate.

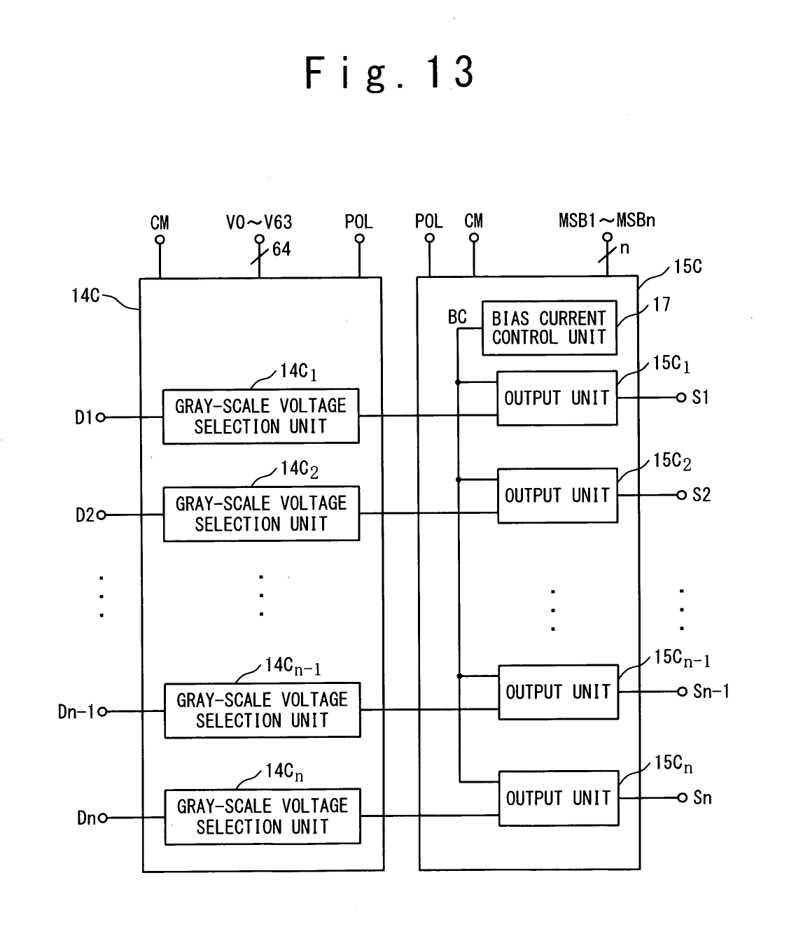

As shown in FIG. 12, the data driver 1C includes a gray-scale voltage selection circuit 14C, an output circuit 15C and a gray-scale voltage generation circuit 16C, instead of the gray-scale voltage selection circuit 14A, the output circuit 15A and the gray-scale voltage generation circuit 16A described in the first embodiment. The gray-scale voltage generation circuit 16C has the same configuration as the gray-scale voltage generation circuit 16A shown in FIG. 6. However, the gray-scale voltage generation circuit 16C outputs the gray-scale voltages V0 to V63 only to the gray-scale voltage selection circuit 14C according to the present embodiment. The gray-scale voltage selection circuit 14C changes the number of gray-scale voltages to be selected, depending on the color mode signal CM. More specifically, in the case of the full-color mode, the gray-scale voltage selection circuit 14C selects gray-scale voltages corresponding to the display data D1 to Dn from all the gray-scale voltages V0 to V63, and outputs the selected gray-scale voltages to the output circuit 15C. In the case of the eight-color mode, on the other hand, the gray-scale voltage selection circuit 14C selects respective gray-scale voltages corresponding to the display data D1 to Dn from the two predetermined gray-scale voltages (e.g. the gray-scale voltages V0 and V63), and outputs the selected gray-scale voltages to the output circuit 15C. The color mode signal CM, the polarity signal POL and the most significant bit MSB1 to MSBn of the respective display data D1 to Dn are input to the output circuit 15C. The output circuit 15C changes the display mode in accordance with the color mode signal CM. In the case of the full-color mode, the output circuit 15C outputs the gray-scale voltages selected by the gray-scale voltage selection circuit 14C as the data signals S1 to Sn to the data lines X1 to Xn, respectively. In the case of the eight-color mode, the output circuit 15C precharges the data lines X1 to Xn to the respective precharge voltages (VDD or GND) and then outputs the gray-scale voltages selected by the gray-scale voltage selection circuit 14C as the data signals S1 to Sn to the data lines X1 to Xn, respectively FIG. 13 is a block diagram showing a configuration of the gray-scale voltage selection circuit 14C and the output circuit 15C according to the present embodiment. The gray-scale voltage selection circuit 14C is provided with gray-scale voltage selection units 14C₁ to 14Cₙ associated with the data lines X1 to Xn, respectively. The output circuit 15C is provided with output units 15C₁ to 15Cₙ associated with the data lines X₁ to Xn, respectively. In the present embodiment, the color mode signal CM and the polarity signal POL are input to the gray-scale voltage selection circuit 14C. In the case of the eight-color mode where the color mode signal CM is “High” level, the gray-scale voltage selection units 14C₁ to 14Cₙ respectively select gray-scale voltages from the two predetermined gray-scale voltages (e.g. the gray-scale voltages V0 and V63), based on the most significant bits of the respective display data D1 to Dn and the polarity signal POL. Then, the gray-scale voltage selection units 14C₁ to 14Cₙ output the selected gray-scale voltages to the respective output units 15C₁ to 15Cₙ. The output circuit 15C receives the two predetermined gray-scale voltages V0 and V63 not from the gray-scale voltage generation circuit 16C but from the gray-scale voltage selection circuit 14C, which is different from the output circuit 15A in the first embodiment. The output units 15C₁ to 15Cₙ apply the gray-scale voltages selected by the gray-scale voltage selection units 14C₁ to 14Cₙ as the data signals S1 to Sn to the data lines X1 to Xn, respectively. The output circuit 15C is further provided with the bias current control unit 17 which is the same as that in the first embodiment. The output circuit 15C does not include the switch control circuit 18A.

Next, the details of the output units 15C₁ to 15Cₙ in the output circuit 15C according to the present embodiment will be described. Since the respective output units 15C₁ to 15Cₙ have the same configuration, the output unit 15C₁ provided between the gray-scale voltage selection unit 14Cn and the data line Xn will be explained as a representative.

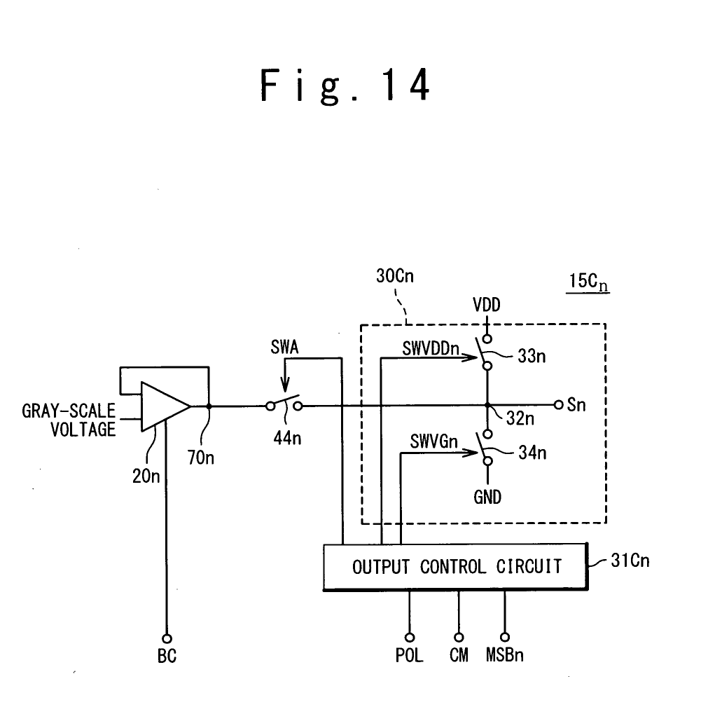

FIG. 14 is a circuit diagram showing a configuration of the output unit 15Cₙ according to the present embodiment. The output unit 15Cₙ is connected to the data line Xn through the output terminal 32n, and outputs a gray-scale voltage corresponding to the display data Dn as the data signal Sn to the data line Xn. As shown in FIG. 14, the output unit 15Cn includes the output terminal 32n, the operational amplifier 20n, a gray-scale voltage control switch 44n, a precharge circuit 30Cn and an output control circuit 31Cn. The gray-scale voltage control switch 44n is provided between the output terminal 32n and a gray-scale voltage supply terminal 70n that is the output terminal of the operational amplifier 20n, and controls an electrical connection between the output terminal 32n and the operational amplifier 20n (gray-scale voltage supply terminal 70n).

The precharge circuit 30Cn includes precharge voltage selection switches 33n and 34n. The precharge voltage selection switch 33n (first precharge voltage selection switch) is provided between the output terminal 32n and the first power source which supplies the power source voltage VDD (first power source voltage) so as to control an electrical connection between the output terminal 32n and the first power source. The precharge voltage selection switch 34n (second precharge voltage selection switch) is provided between the output terminal 32n and the second power source which supplies the ground voltage GND (second power source voltage) so as to control an electrical connection between the output terminal 32n and the second power source.

The output control circuit 31Cn controls the precharge voltage selection switches 33n and 34n and the gray-scale voltage control switch 44n based on the polarity signal POL, the color mode signal CM and the most significant bit MSBn of the display data Dn. More specifically, the output control circuit 31Cn generates voltage selection signals SWVDDn and SWVGn and a gray-scale voltage control signal SWA based on the polarity signal POL, the color mode signal CM and the most significant bit MSBn of the display data Dn. Then, the output control circuit 31Cn outputs the voltage selection signals SWVDDn and SWVGn and the gray-scale voltage control signal SWA to control the precharge voltage selection switches 33n and 34n and the gray-scale voltage control switch 44n, respectively.

In the case of the full-color mode (normal mode) where the color mode signal CM(Low) is input to the output control circuit 31Cn, the output control circuit 31Cn outputs the voltage selection signals SWVDDn(Low) and SWVGn(Low) to the precharge voltage selection switches 33n and 34n, respectively. Thus, the precharge voltage selection switches 33n and 34n are turned OFF, and the precharge circuit 30Cn is deactivated. At the same time, the output control circuit 31Cn outputs the gray-scale voltage control signal SWA(Hi) so as to turn ON the gray-scale voltage control switch 44n. Moreover, the bias current control unit 17 (see FIG. 13) supplies the bias current BC to the operational amplifier 20n when the gray-scale voltage control switch 44n is turned ON. In this case, a gray-scale voltage which is selected by the gray-scale voltage selection unit 14Cₙ (see FIG. 13) and corresponds to the display data Dn is output as the data signal Sn from the operational amplifier 20n to the data line Xn through the output terminal 32n.

In the case of the eight-color mode where the color mode signal CM(Hi) is input to the output control circuit 31Cn, on the other hand, the precharge circuit 30Cn is activated. That is to say, the precharge circuit 30Cn precharges the output terminal 32n to the precharge voltage (VDD or GND) before the gray-scale voltage (V0 or V63) is applied to the data line Xn.

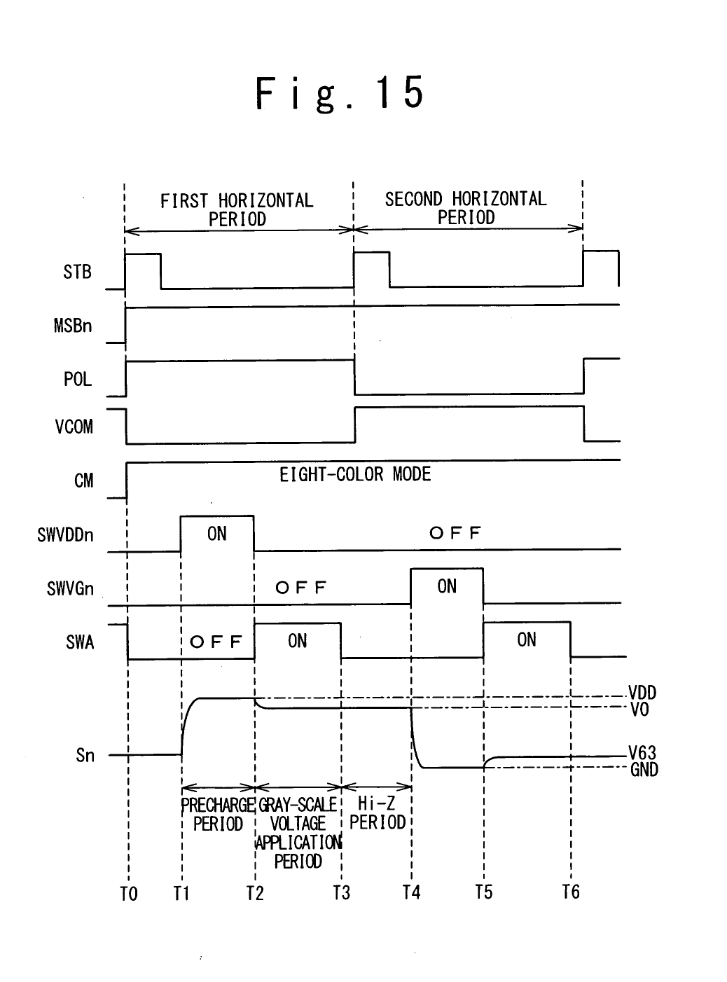

FIG. 15 is a timing chart showing an operation example of the output unit 15Cₙ during the eight-color mode according to the present embodiment. The strobe signal STB, the most significant bit MSBn of the display data Dn, the polarity signal POL, the common voltage VCOM, the color mode signal CM, the voltage selection signals SWVDDn and SWGn, the gray-scale voltage control signal SWA and the data signal Sn are shown in FIG. 15. In the initial state of one horizontal period, the precharge voltage selection switches 33n and 34n are turned OFF.

At time T0, a first horizontal period starts. In the first horizontal period, the polarity signal POL is “High” level and the most significant bit MSBn input to the output unit 15Cₙ is “1”. At the time T0, the color mode signal CM changes from “Low” to “Hi” and the output unit 15Cₙ enters the eight-color mode. In response to the color mode signal CM(Hi), the output control circuit 31Cn outputs the gray-scale voltage control signal SWA(Low) so as to turn OFF the gray-scale voltage control switch 44n. When the gray-scale voltage control switch 44n is turned OFF, the bias current control unit 17 (see FIG. 13) stops supplying of the bias current BC to the operational amplifier 20n.

At time T1, the output control circuit 31Cn outputs the voltage selection signals SWVDDn(Hi) and SWVGn(Low) in accordance with the polarity signal POL(Hi) and the most significant bit MSBn=1. In response to these voltage selection signals, the precharge voltage selection switch 33n is turned ON and thus the output terminal 32n is precharged to the power source voltage VDD (precharge voltage).

At time T2 after the precharge period, the output control circuit 31Cn changes the voltage selection signal SWVDDn to “Low” and the gray-scale voltage control signal SWA to “Hi”. Thus, the precharge voltage selection switch 33n is turned OFF, while the gray-scale voltage control switch 44n is turned ON. When the gray-scale voltage control switch 44n is turned ON, the bias current control unit 17 (see FIG. 13) supplies the bias current BC to the operational amplifier 20n. Consequently, the gray-scale voltage V0 (first gray-scale voltage) selected by the gray-scale voltage selection unit 14Cₙ is supplied to the output terminal 32n from the operational amplifier 20n.

From the time T2 to T3 (gray-scale voltage application period), the gate driver 2 drives one of the scan lines Y1 to Ym, and the gray-scale voltage V0 is applied as the data signal Sn to a pixel through the data line Xn. At the time T3 after the gray-scale voltage application period, the output control circuit 31Cn changes the gray-scale voltage control signal SWA to “Low” so as to turn OFF the gray-scale voltage control switch 44n.

From the time T3 to T4 (Hi-Z period), the output terminal 32n is set to the high-impedance state. During this Hi-Z period, the first horizontal period is ended and the next horizontal period (second horizontal period) is started. In the second horizontal period, the polarity signal POL is “Low” level and the most significant bit MSBn is “1”. That is, the polarity signal POL is switched from “Hi” to “Low”, and the polarity of the common voltage VCOM is inverted.

At time T4, the output control circuit 31Cn outputs the voltage selection signals SWVDDn(Low) and SWVGn(Hi) in accordance with the polarity signal POL(Low) and the most significant bit MSBn=1. In response to these voltage selection signals, the precharge voltage selection switch 34n is turned ON and thus the output terminal 32n is precharged to the ground voltage GND (precharge voltage).

At time T5 after the precharge period, the output control circuit 31Cn changes the voltage selection signal SWVGn to “Low” and the gray-scale voltage control signal SWA to “Hi”. Thus, the precharge voltage selection switch 34n is turned OFF, while the gray-scale voltage control switch 44n is turned ON. Consequently, the gray-scale voltage V63 (second gray-scale voltage) selected by the gray-scale voltage selection unit 14Cₙ is supplied to the output terminal 32n from the operational amplifier 20n.

From the time T5 to T6 (gray-scale voltage application period), the gate driver 2 drives one of the scan lines Y1 to Ym, and the gray-scale voltage V63 is applied as the data signal Sn to a pixel through the data line Xn. At the time T6 after the gray-scale voltage application period, the output control circuit 31Cn changes the gray-scale voltage control signal SWA to “Low” so as to turn OFF the gray-scale voltage control switch 44n.

As described above, the data driver 1C according to the present embodiment can be switched from the normal mode (full-color mode) to the eight-color mode. In the eight-color mode, the data driver 1C outputs the two predetermined gray-scale voltages (V0, V63) as the data signals S1 to Sn to the respective data lines X1 to Xn for driving each pixel on the LCD panel 3.

As described above, the data driver 1C according to the present embodiment precharges the data lines X1 to Xn before the data signals S1 to Sn are applied to the respective data lines X1 to Xn. For example, the data line Xn is precharged to the power source voltage VDD or the ground voltage GND depending on the display data Dn. In other words, the data line Xn is precharged to the precharge voltage (VDD or GND) which is near the gray-scale voltage (V0 or V63) during the precharge period. Therefore, when the data signal Sn is applied to a pixel, the load for outputting the data signal Sn can be reduced. That is to say, the load applied to an operational amplifier in the gray-scale voltage selection circuit 14C can be reduced when the gray-scale voltage (V0 or V63) is supplied to the data lines X1 to Xn during the eight-color mode. Since the voltage drop can be suppressed sufficiently, it is not necessary to provide a capacitor connected to an output terminal of the operational amplifier. Consequently, the cost of manufacturing can be reduced.

### 5. Fourth Embodiment

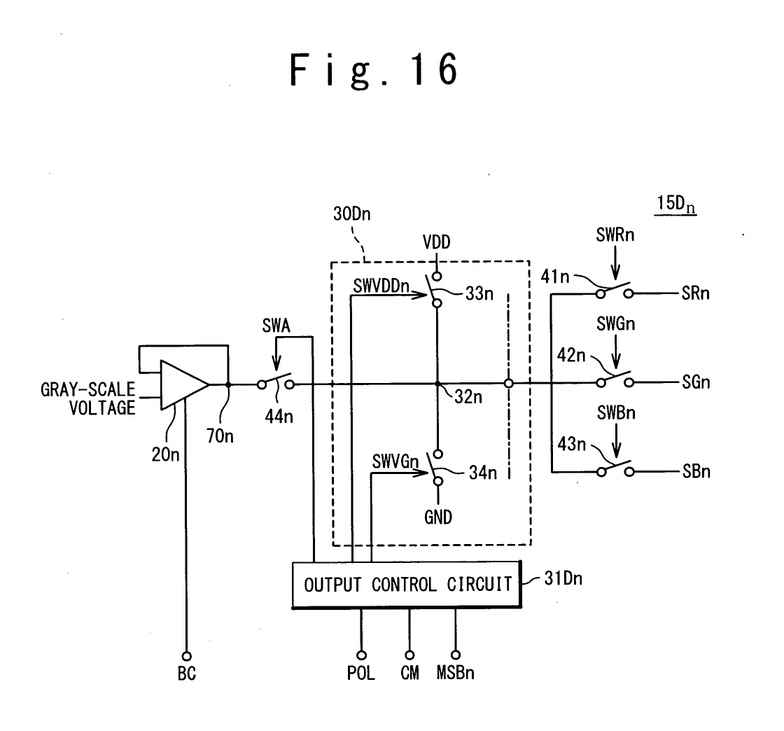

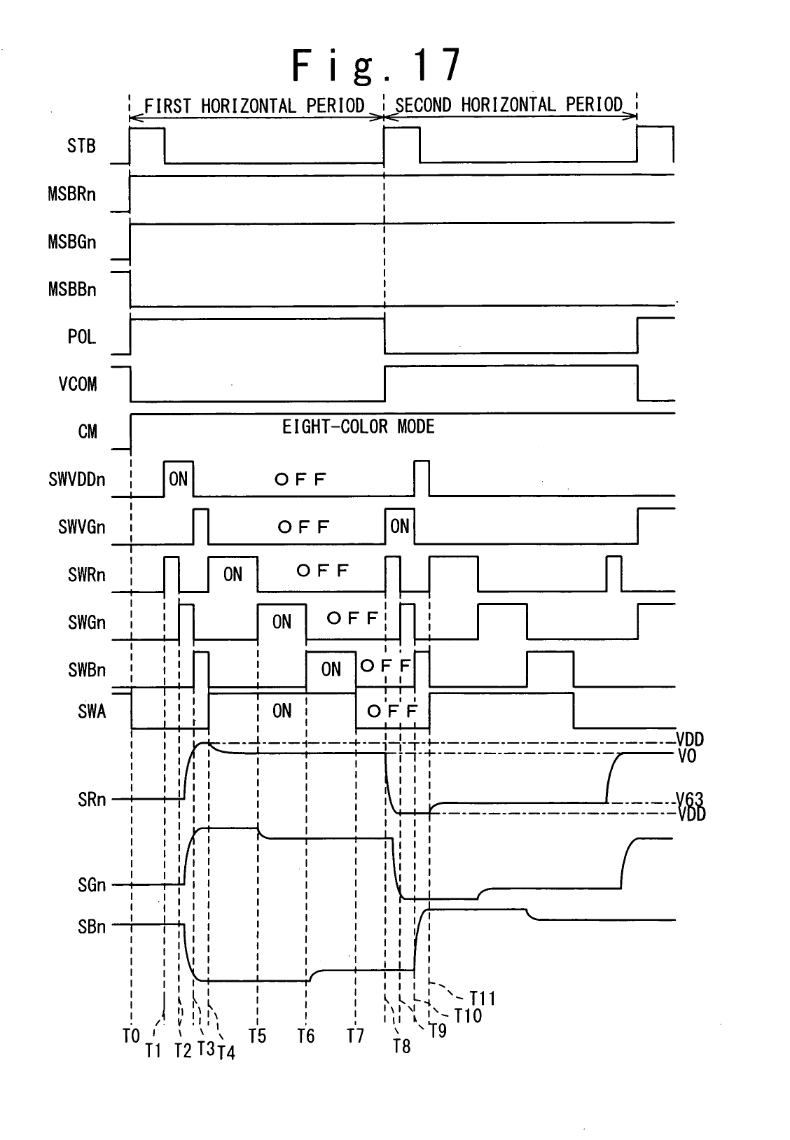

Referring to FIGS. 16 and 17, the data driver 1 according to a fourth embodiment will be explained. In the fourth embodiment, the data driver 1 performs “time-division driving” based on the above-mentioned third embodiment. In the fourth embodiment, the same reference numerals are given to the same components as those described in the third embodiment, and an overlapping description will be omitted as appropriate. In the fourth embodiment, the data driver 1 is provided with output units 15D₁ to 15Dₙ instead of the output units 15C₁ to 15Cₙ described in the third embodiment. The most significant bits MSBR1 to MSBRn (associated with the display color “R (Red)”, MSBG1 to MSBGn (associated with the display color “G (Green)” and MSBB1 to MSBBn (associated with the display color “B (Blue)” of the display data Dn are input to the output units 15D₁ to 15Dₙ, respectively. The output units 15D₁ to 15Dₙ output data signals SR1 to SRn, SG1 to SGn and SB1 to SBn to data lines XR1 to XRn (associated with the display color “R”), XG1 to XGn (associated with the display color “G”) and XB1 to XBn (associated with the display color “B”), respectively. Since the respective output units 15D₁ to 15Dₙ have the same configuration, the output unit 15Dₙ provided between the gray-scale voltage selection unit 14Cn and the data lines XRn, XGn and XBn will be explained as a representative.

FIG. 16 is a circuit diagram showing a configuration of the output unit 15Dₙ according to the present embodiment. The output unit 15Dₙ is connected to the data lines XRn, XGn and XBn which are respectively connected to pixels of the display colors RGB. As shown in FIG. 16, the output unit 15Dn includes the output terminal 32n, the operational amplifier 20n, the gray-scale voltage control switch 44n, color selection switches 41n, 42n and 43n, a precharge circuit 30Dn and an output control circuit 31Dn. The precharge circuit 30Dn includes the precharge voltage selection switches 33n and 34n. The color selection switches 41n, 42n and 43n are provided between the output terminal 32n and the data lines XRn, XGn and XBn, respectively. The color selection switches 41n, 42n and 43n respectively control electrical connections between the output terminal 32n and the data lines XRn, XGn and XBn in accordance with color selection signals SWRn, SWGn and SWBn which are transmitted from a control circuit (not shown).

In the case of the full-color mode (normal mode) where the color mode signal CM(Low) is input to the output control circuit 31Dn, the output control circuit 31Dn outputs the voltage selection signals SWVDDn(Low) and SWVGn(Low) to the precharge voltage selection switches 33n and 34n, respectively. Thus, the precharge voltage selection switches 33n and 34n are turned OFF, and the precharge circuit 30Dn is deactivated. At the same time, the output control circuit 31Dn outputs the gray-scale voltage control signal SWA(Hi) so as to turn ON the gray-scale voltage control switch 44n. Moreover, the color selection switches 41n, 42n and 43n are turned ON in order. In this case, gray-scale voltages which are selected by the gray-scale voltage selection unit 14Cₙ and correspond to the RGB of the display data Dn are output as the data signals SRn, SGn and SBn in order from the operational amplifier 20n to the data lines XRn, XGn and XBn, respectively.

In the case of the eight-color mode where the color mode signal CM(Hi) is input to the output control circuit 31Dn, on the other hand, the precharge circuit 30Dn is activated. That is to say, the precharge circuit 30Dn precharges the output terminal 32n to the precharge voltage (VDD or GND) before the gray-scale voltage (V0 or V63) is applied to the output terminal 32n. In other words, the data lines XRn, XGn and XBn are precharged before the data signals SRn, SGn and SBn are output to the data lines XRn, XGn and XBn, respectively.

FIG. 17 is a timing chart showing an operation example of the output unit 15Dₙ during the eight-color mode according to the present embodiment. In the initial state of one horizontal period, the precharge voltage selection switches 33n and 34n and the color selection switches 41n, 42n and 43n are turned OFF.

At time T0, a first horizontal period starts. In the first horizontal period, the polarity signal POL is “High” level, and the most significant bits MSBRn, MSBGn and MSBBn input to the output unit 15Dₙ are “1”, “1” and “0”, respectively. At the time T0, the color mode signal CM changes from “Low” to “Hi” and the output unit 15Dₙ enters the eight-color mode. In response to the color mode signal CM(Hi), the output control circuit 31Dn outputs the gray-scale voltage control signal SWA(Low) so as to turn OFF the gray-scale voltage control switch 44n. When the gray-scale voltage control switch 44n is turned OFF, the bias current control unit 17 (see FIG. 13) stops supplying of the bias current BC to the operational amplifier 20n.

From time T1 to T4, the color selection signals SWRn(Hi), SWGn(Hi) and SWBn(Hi) are input to the output unit 15Dₙ in order. More specifically, the color selection signal SWRn(Hi) is input from the time T1 to T2, the color selection signal SWGn(Hi) is input from the time T2 to T3, and the color selection signal SWBn(Hi) is input from the time T3 to T4. In response to these color selection signals, the color selection switches 41n, 42n and 43n are turned ON in order. Thus, the output terminal 32n is electrically connected to the data lines XRn, XGn and XBn in order.

At the time T1, the output control circuit 31Dn outputs the voltage selection signals SWVDDn(Hi) and SWVGn(Low) in accordance with the polarity signal POL(Hi) and the most significant bit MSBRn=1. In response to these voltage selection signals, the precharge voltage selection switch 33n is turned ON. Since the color selection switch 41n is turned ON from the time T1 to T2, the output terminal 32n and the data line XRn are precharged to the power source voltage VDD (precharge voltage).

At the time T2, the output control circuit 31Dn outputs the voltage selection signals SWVDDn(Hi) and SWVGn(Low) in accordance with the polarity signal POL(Hi) and the most significant bit MSBGn=1. In response to these voltage selection signals, the precharge voltage selection switch 33n is turned ON. Since the color selection switch 42n is turned ON from the time T2 to T3, the output terminal 32n and the data line XGn are precharged to the power source voltage VDD (precharge voltage).

At the time T3, the output control circuit 31Dn outputs the voltage selection signals SWVDDn(Low) and SWVGn(Hi) in accordance with the polarity signal POL(Hi) and the most significant bit MSBBn=0. In response to these voltage selection signals, the precharge voltage selection switch 34n is turned ON. Since the color selection switch 43n is turned ON from the time T3 to T4, the output terminal 32n and the data line XBn are precharged to the ground voltage GND (precharge voltage).

After all the data lines XRn, XGn and XBn are precharged, the output control circuit 31Dn sets the voltage selection signals SWVDDn and SWVGn to “Low” so as to turn OFF the precharge voltage selection switches 33n and 34n. From the time T4 to T7 after the precharge period, the output control circuit 31Dn sets the gray-scale voltage control signal SWA to “Hi” so as to turn ON the gray-scale voltage control switch 44n. When the gray-scale voltage control switch 44n is turned ON, the bias current control unit 17 (see FIG. 13) supplies the bias current BC to the operational amplifier 20n. Consequently, the gray-scale voltage (V0 or V63) selected by the gray-scale voltage selection unit 14Cₙ is supplied to the output terminal 32n from the operational amplifier 20n.

Moreover, from the time T4 to T7, the color selection signals SWRn(Hi), SWGn(Hi) and SWBn(Hi) are input to the output unit 15Dₙ in order. More specifically, from the time T4 to T5, the color selection signal SWRn(Hi) is input and the color selection switch 41n is turned ON. Consequently, the gray-scale voltage V0 selected by the gray-scale voltage selection unit 14Cₙ is output as the data signal SRn from the operational amplifier 20n to the data line XRn that has been precharged to the power source voltage VDD. From the time T5 to T6, the color selection signal SWGn(Hi) is input and the color selection switch 42n is turned ON. Consequently, the gray-scale voltage V0 selected by the gray-scale voltage selection unit 14Cₙ is output as the data signal SGn from the operational amplifier 20n to the data line XGn that has been precharged to the power source voltage VDD. From the time T6 to T7, the color selection signal SWBn(Hi) is input and the color selection switch 43n is turned ON. Consequently, the gray-scale voltage V63 selected by the gray-scale voltage selection unit 14Cₙ is output as the data signal SBn from the operational amplifier 20n to the data line XBn that has been precharged to the ground voltage GND.

From the time T4 to T7 (gray-scale voltage application period), the gate driver 2 drives one of the scan lines Y1 to Ym, and the data signals SRn, SGn and SBn (gray-scale voltage V0 or V63) are applied to a pixel through the data line XRn, XGn and XBn, respectively. At the time T7 after the gray-scale voltage application period, the output control circuit 31Dn changes the gray-scale voltage control signal SWA to “Low” so as to turn OFF the gray-scale voltage control switch 44n.

From the time T7 to T8 (Hi-Z period), the output terminal 32n is set to the high-impedance state. During this Hi-Z period, the first horizontal period is ended and the next horizontal period (second horizontal period) is started. In the second horizontal period, the polarity signal POL is “Low” level, and the most significant bits MSBRn, MSBGn and MSBBn input to the output unit 15Dₙ are “1”, “1” and “0”, respectively. That is, the polarity signal POL is switched from “Hi” to “Low”, and the polarity of the common voltage VCOM is inverted.

From time T8 to T11, the color selection signals SWRn(Hi), SWGn(Hi) and SWBn(Hi) are input to the output unit 15Dₙ in order. More specifically, the color selection signal SWRn(Hi) is input from the time T8 to T9, the color selection signal SWGn(Hi) is input from the time T9 to T10, and the color selection signal SWBn(Hi) is input from the time T10 to T11. In response to these color selection signals, the color selection switches 41n, 42n and 43n are turned ON in order. Thus, the output terminal 32n is electrically connected to the data lines XRn, XGn and XBn in order.

At the time T8, the output control circuit 31Dn outputs the voltage selection signals SWVDDn(Low) and SWVGn(Hi) in accordance with the polarity signal POL(Low) and the most significant bit MSBRn=1. In response to these voltage selection signals, the precharge voltage selection switch 34n is turned ON. Since the color selection switch 41n is turned ON from the time T8 to T9, the output terminal 32n and the data line XRn are precharged to the ground voltage GND (precharge voltage).

At the time T9, the output control circuit 31Dn outputs the voltage selection signals SWVDDn(Low) and SWVGn(Hi) in accordance with the polarity signal POL(Low) and the most significant bit MSBGn=1. In response to these voltage selection signals, the precharge voltage selection switch 34n is turned ON. Since the color selection switch 42n is turned ON from the time T9 to T10, the output terminal 32n and the data line XGn are precharged to the ground voltage GND (precharge voltage).

At the time T10, the output control circuit 31Dn outputs the voltage selection signals SWVDDn(Hi) and SWVGn(Low) in accordance with the polarity signal POL(Low) and the most significant bit MSBBn=0. In response to these voltage selection signals, the precharge voltage selection switch 33n is turned ON. Since the color selection switch 43n is turned ON from the time T10 to T11, the output terminal 32n and the data line XBn are precharged to the power source voltage VDD (precharge voltage).

After all the data lines XRn, XGn and XBn are precharged, the output control circuit 31Dn sets the voltage selection signals SWVDDn and SWVGn to “Low” so as to turn OFF the precharge voltage selection switches 33n and 34n. After that, the gray-scale voltage V63, V63 and V0 are output as the data signals SRn, SGn and SBn in order to the data lines XRn, XGn and XBn, respectively. The gate driver 2 drives one of the scan lines Y1 to Ym, and the data signals SRn, SGn and SBn (gray-scale voltage V0 or V63) are applied to a pixel through the data line XRn, XGn and XBn, respectively.

As described above, even in the present embodiment where the data driver 1 performs the time-division driving, each of the data lines XRn, XGn and XBn can be precharged to the precharge voltage (VDD or GND) before the data signals SRn, SGn and SBn (V0 or V63) are applied to the respective data lines XRn, XGn and XBn. Therefore, the load for outputting the data signals SRn, SGn and SBn can be reduced. That is to say, the load applied to an operational amplifier in the gray-scale voltage selection circuit 14C can be reduced when the gray-scale voltage (V0 or V63) is supplied to the data lines during the eight-color mode. Since the voltage drop can be suppressed sufficiently, it is not necessary to provide a capacitor connected to an output terminal of the operational amplifier. Consequently, the cost of manufacturing can be reduced.

In the above description, the liquid crystal display device 10 employing the line inversion driving method has been explained as an example. The present invention can also be applied to the frame inversion driving method and the dot inversion driving method. Moreover, the present invention can also be applied to other display devices such as an ELD (ElectroLuminescence Display) and the like. Furthermore, the color mode of the display panel 3 can be changed wholly or partially. For example, it is possible to set the central area of the screen (display panel 3) to the full-color mode while the peripheral area to the eight-color mode.

Moreover, the precharging by the precharge circuit according to the present invention can also be applied to the full-color mode. For example, if the data signals S1 to Sn of the same gray-scale voltage (e.g. the gray-scale voltage V0) are applied to the respective data lines X1 to Xn during the full-color mode, the load imposed on the operational amplifier is increased as in the eight-color mode. Therefore, the output circuit 15 may precharge the data lines X1 to Xn to a precharge voltage (e.g. the power source voltage VDD) before the data signals S1 to Sn are output to the respective data lines X1 to Xn in order to reduce the load applied to the operational amplifier, even in the full-color mode.

It is apparent that the present embodiment is not limited to the above embodiments and may be modified and changed without departing from the scope and spirit of the invention.

What is claimed is:

1. A data line driving circuit in a display device comprising:
an output terminal connected to a pixel of a display panel through a data line, wherein a gray-scale voltage corresponding to a display data is applied to said data line through said output terminal; and
a precharge circuit configured to precharge said output terminal to a precharge voltage before said gray-scale voltage is applied to said data line, wherein said precharge voltage depends on said gray-scale voltage.

2. The data line driving circuit according to claim 1,
wherein said display device operates in a first mode and a second mode, and a number of colors displayed on said display panel is larger in said first mode than in said second mode,
wherein said precharge circuit is deactivated in said first mode while activated in said second mode.

3. The data line driving circuit according to claim 2,
wherein said precharge circuit selects one of a plurality of power sources depending on said display data and connects said output terminal with said selected one power source when precharging said output terminal in said second mode.

4. The data line driving circuit according to claim 3,
wherein said plurality of power sources includes:
a first power source configured to supply a first power source voltage; and
a second power source configured to supply a second power source voltage lower than said first power source voltage,
wherein said precharge circuit includes:
a first precharge voltage selection switch provided between said first power source and said output terminal; and
a second precharge voltage selection switch provided between said second power source and said output terminal, and
wherein said precharge circuit turns on one of said first precharge voltage selection switch and said second precharge voltage selection switch depending on said display data.

5. The data line driving circuit according to claim 4,
wherein said precharge circuit turns on one of said first precharge voltage selection switch and said second precharge voltage selection switch depending on the most significant bit of said display data.

6. The data line driving circuit according to claim 4,
wherein in said second mode, a first gray-scale voltage or a second gray-scale voltage lower than said first gray-scale voltage is applied as said gray-scale voltage to said data line,
wherein when said gray-scale voltage is said first gray-scale voltage, said precharge circuit turns on said first precharge voltage selection switch while turns off said second precharge voltage selection switch, and
wherein when said gray-scale voltage is said second gray-scale voltage, said precharge circuit turns off said first precharge voltage selection switch while turns on said second precharge voltage selection switch.

7. The data line driving circuit according to claim 6,
wherein said first gray-scale voltage is the maximum one of a plurality of gray-scale voltages used for driving said display panel in said first mode, and said second gray-scale voltage is the minimum one of said plurality of gray-scale voltages.

8. A display device comprising:
a display panel having a pixel connected to a data line; and
a data line driving circuit connected to said data line through an output terminal and configured to apply a gray-scale voltage corresponding to a display data to said data line,
wherein said data line driving circuit comprises a precharge circuit configured to precharge said output terminal to a precharge voltage before said gray-scale voltage is applied to said data line,
wherein said precharge voltage depends on said gray-scale voltage.

9. The display device according to claim 8,
wherein the display device operates in a first mode and a second mode, and a number of colors displayed on said display panel is larger in said first mode than in said second mode,
wherein said precharge circuit is deactivated in said first mode while activated in said second mode.

10. The display device according to claim 9,
wherein said precharge circuit selects one of a plurality of power sources depending on said display data and connects said output terminal with said selected one power source when precharging said output terminal in said second mode.

11. The display device according to claim 10,
wherein said plurality of power sources includes:
a first power source configured to supply a first power source voltage; and
a second power source configured to supply a second power source voltage lower than said first power source voltage,
wherein said precharge circuit includes:
a first precharge voltage selection switch provided between said first power source and said output terminal; and
a second precharge voltage selection switch provided between said second power source and said output terminal, and
wherein said precharge circuit turns on one of said first precharge voltage selection switch and said second precharge voltage selection switch depending on said display data.

12. The display device according to claim 11,
wherein said precharge circuit turns on one of said first precharge voltage selection switch and said second precharge voltage selection switch depending on the most significant bit of said display data.

13. The display device according to claim 11,
wherein in said second mode, said data line driving circuit applies a first gray-scale voltage or a second gray-scale voltage lower than said first gray-scale voltage to said data line as said gray-scale voltage,
wherein when said gray-scale voltage is said first gray-scale voltage, said precharge circuit turns on said first precharge voltage selection switch while turns off said second precharge voltage selection switch, and
wherein when said gray-scale voltage is said second gray-scale voltage, said precharge circuit turns off said first precharge voltage selection switch while turns on said second precharge voltage selection switch.

14. The display device according to claim 13,
wherein said first gray-scale voltage is the maximum one of a plurality of gray-scale voltages used for driving said display panel in said first mode, and said second gray-scale voltage is the minimum one of said plurality of gray-scale voltages.

15. A method of driving a data line connected to a pixel of a display panel of a display device, comprising:
precharging said data line to a precharge voltage; and
applying a gray-scale voltage corresponding to a display data to said data line after said precharging,
wherein said precharge voltage depends on said gray-scale voltage.

16. The method according to claim 15,
wherein in said applying, a first gray-scale voltage or a second gray-scale voltage lower than said first gray-scale voltage is applied as said gray-scale voltage to said data line depending on said display data.

17. The method according to claim 16,
wherein in said precharging, said precharge voltage is a first power source voltage when said gray-scale voltage is said first gray-scale voltage, while said precharge voltage is a second power source voltage lower than said first power source voltage when said gray-scale voltage is said second gray-scale voltage.

18. The method according to claim 17,
wherein said precharging includes:
selecting one of said first power source voltage and said second power source voltage depending on said display data; and
applying said selected one power source voltage as said precharge voltage to said data line.
